(19) United States
(12) Patent Application Publication
(10) Pub. No.: US 2012/0076085 A1
(43) Pub. Date: Mar. 29, 2012

(54) GROUP PAGING METHOD AND WIRELESS COMMUNICATION DEVICE AND BASE STATION AND PAGING CONTROLLER USING THE SAME

(75) Inventor: Chie-Ming Chou, Taichung City (TW)

(73) Assignee: Industrial Technology Research Institute, Hsinchu (TW)

(21) Appl. No.: 13/207,444

(22) Filed: Aug. 11, 2011

Related U.S. Application Data
(60) Provisional application No. 61/386,222, filed on Sep. 24, 2010.

(51) Int. Cl. H04W 68/00; H04W 74/08

(52) U.S. Cl. 370/329; 370/328

(57) ABSTRACT

Group paging methods and wireless communication devices and base stations using the same methods are proposed. In some embodiments, group identifiers are partitioned into different pools and assigned to wireless communication devices based on their mobility. When a base station intends to perform group paging, specific devices, not responded to the previous group paging, will be paged, or the group paging is repeated, and the other devices which responded to the previous group paging ignore the repeated group paging in a period of time. In other embodiments, a device responds to the group paging at the opportunity of random access process based on the indicator given in its idle information or the indicator given in paging message with some pre-determined mathematical operation or the pre-determined mathematical calculations on its device identity.

### CROSS-REFERENCE TO RELATED APPLICATION

This application claims the priority benefits of U.S. provisional application Ser. No. 61/386,222, filed on Sep. 24, 2010. The entirety of the above-mentioned patent application is hereby incorporated by reference herein and made a part of this specification.

### TECHNICAL FIELD

The disclosure generally relates to a group paging method for classified (grouped) wireless communication devices, and wireless communication devices, base stations and a paging controller using the same methods.

### BACKGROUND

In recent years, the cost of access to public wireless data networks has been dropping while the capabilities of these networks continue to increase. Machine type communications (MTC) or so-called Machine to Machine (M2M) communication is a new technology that enables these networks to bring smart services to a much wider audience. Recent studies have scoped out the huge potential for this market, with millions of devices being connected over the next few years and thus generate huge revenues. Different from the traditional Human to Human (H2H) communications, MTC is seen as a form of data communication between entities that do not necessarily need (or involve) human interaction. It is different to current network as it involves new or different market scenarios, low costs and effort, a potentially very large number of communicating terminals, and small and infrequent traffic transmission per terminal. As a result, the industry has been working together to provide MTC and smart services offerings across a wide variety of market segments, including healthcare, manufacturing, utilities, distribution and consumer products.

There are cellular MTC technologies proposed for enabling MTC through cellular network architecture and system such as LTE/LTE-A/WiMAX system. The working models of the cellular MTC technologies can offer significant advantages such as: ubiquitous coverage, mobility support, broadband rate, lower cost through conventional wireless structure.

However, the working model of the cellular MTC technologies also influences human-to-human (H2H) communication devices due to shared resources in the cellular communication network. The most significant problem occurs on random access channel (RACH). Before beginning any transmission, a user entity (UE) or a wireless communication devices needs to perform random access process is required to attach uplink synchronization, acquire the available resources. In traditional, the intensity of random access channel is small in an access base station. The term “eNB” will be used throughout the present disclosure to represent the access base station. Potentially very large number of MTC devices can easily cause the RACH congestion and degrade the system performance. Therefore, physical (PHY) layer or medium access control (MAC) layer enhancements are required to handle extremely large amount of RACH attempts in cellular MTC.

There are several schemes proposed to deal with the RACH congestion of large amount of RACH attempts in the cellular MTC. One of the proposed schemes is Group paging scheme. In the group paging scheme, the cellular communication network sever can page the MTC devices to pull information from the device, or send information to the device in a time-controlled managements. With the time control, the cellular communication network can distribute the RACH loading and avoid the collision. However, considering the mass deployment of MTC devices, the one-by-one paging message consumes massive system resource and introduces long paging delay. A group based approach is proposed for resolving this issue. FIG. 1 illustrates an example of group paging scheme. Referring to FIG. 1, the MTC devices in one group can use an assigned group paging identifier (ID) to calculate the paging frame (PF) and paging occurrence (PO) instead of using its own UE identity (serving temporary mobile subscriber identity, S-TMSI, as shown in FIG. 2). Then, on that time (corresponding to the PF and the PO), the MTC devices can monitor the physical downlink control channel (PDCCH) and try to receive the paging message from associated eNB if the Paging Radio Network Temporary Identifier (P-RNTI) is placed in the PDCCH. When the group paging ID is recorded on that paging message, the MTC devices can then perform RACH attempt to communicate with eNB.

However, there are other concerns of group paging such as: how to group and arrange the group paging IDs for different MTC devices (the grouping assignment criteria); how to ensure every MTC device listen to and respond the corresponding group paging; and how to reduce the RACH collision when all MTC devices in the same group may perform the RACH attempts simultaneously. Therefore, it is a major issue to modify conventional group paging scheme for enhancing its performance as well as achieving less network overhead and lower collision rate in random access process.

### SUMMARY

An exemplary embodiment of a group paging method is introduced herein. According to an exemplary embodiment, the group paging method is adapted for paging a plurality of wireless communication devices, and includes following steps: reporting, at a wireless communication device, a mobility information to a base station when camping on the base station; receiving, at the wireless communication device, a message indicating an assigned group paging identifier according to the mobility information; and receiving, at the wireless communication device, a paging message comprising the assigned group paging identifier.

An exemplary embodiment of a group paging method is introduced herein. According to an exemplary embodiment, the group paging method is adapted for a base station paging a plurality of wireless communication devices, and includes following steps: receiving, at the base station, a mobility information respectively from the wireless communication devices; forwarding, at the base station, the mobility information to a paging controller; receiving, at the base station, group paging identifiers assigned to the wireless communication devices respectively according to the mobility information; transmitting, at the base station, at least a message indicating the respectively assigned group paging identifiers to the wireless communication devices; and transmitting, at the base station, a paging message comprising the assigned group identifier, to one group of the wireless communication devices.

An exemplary embodiment of a wireless communication device is introduced herein. According to an exemplary embodiment, the wireless communication device is adapted for responding to group paging of a base station, and includes a transceiver module and a communication protocol module. The transceiver module is configured for transmitting signal to the base station and receiving signal from the base station. The communication protocol module is connected to the transceiver module, and is configured for reporting a mobility information to the base station when camping on the base station, receiving message indicating an assigned group paging identifier according to the mobility information, and receiving a paging message comprising the assigned group identifier.

An exemplary embodiment of a base station is introduced herein. According to an exemplary embodiment, the base station is adapted for paging a plurality of wireless communication devices, and includes a transceiver module and a communication protocol module. The transceiver module is configured for transmitting signal to at least one wireless communication device and receiving signal from the at least one wireless communication device. The communication protocol module is connected to the transceiver module, and is configured for receiving mobility information respectively from the at least one wireless communication devices, forwarding the mobility information to a paging controller, receiving group paging identifiers assigned to the wireless communication devices respectively according to the mobility information, transmitting at least a message indicating the respectively assigned group paging identifiers to the wireless communication devices, and transmitting a paging message, comprising the assigned group identifier, to one paging group of the wireless communication devices.

An exemplary embodiment of a group paging method is introduced herein. According to an exemplary embodiment, the group paging method is adapted for paging a plurality of wireless communication devices, and includes following steps: when receiving a first paging message with an assigned group paging identifier from a base station, a wireless communication device replying at least a content to the base station; and when receiving a second paging message with the assigned group identifier, the wireless communication device, which has responded previously to the first paging message, determining to ignore the second paging message.

An exemplary embodiment of a group paging method is introduced herein. According to an exemplary embodiment, the group paging method is adapted for a base station paging a plurality of wireless communication devices, and includes following steps: transmitting, at the base station, a first paging message with an assigned group paging identifier to a paging group of wireless communication devices; receiving, the base station, at least a content respectively from some wireless communication devices in the paging group; checking, the base station, the at least a replied content respectively from the some wireless communication devices in the paging group; and determining, the base station, to transmit a second paging message or transmit at least a paging message with at least a device identifier respectively to the wireless communication devices which did not respond to the first paging message or terminate the paging.

An exemplary embodiment of a wireless communication device is introduced herein. According to an exemplary embodiment, the wireless communication device is adapted for responding to group paging of a base station, and includes a transceiver module and a communication protocol module. The transceiver module is configured for transmitting signal to the base station and receiving signal from the base station. The communication protocol module is connected to the transceiver module, and is configured for transmitting a first paging message with an assigned group identifier to a paging group of wireless communication devices, receiving at least a content respectively from some wireless communication devices in the paging group, and checking the at least a replied content respectively from the wireless communication devices in the paging group. In addition, the communication protocol module, which has responded previously to the first paging, determines to ignore a second paging with the assigned group identifier when receiving the second paging message.

An exemplary embodiment of a base station is introduced herein. According to an exemplary embodiment, the base station is adapted for paging a plurality of wireless communication devices, and includes a transceiver module and a communication protocol module. The transceiver module is configured for transmitting signal to at least one wireless communication device and receiving signal from the at least one wireless communication device. The communication protocol module is connected to the transceiver module, and is configured for transmitting a first paging message with an assigned group identifier to a paging group of wireless communication devices, receiving at least a content respectively from some wireless communication devices in the paging group, and checking the at least a replied content respectively from the wireless communication devices in the paging group. In addition, the communication protocol module is configured for further determining to transmit a second paging message or transmit at least a paging message with at least a device identifier respectively to the wireless communication devices which did not respond to the first group paging, or terminate the paging.

An exemplary embodiment of a group paging method is introduced herein. According to an exemplary embodiment, the group paging method is adapted for paging a plurality of wireless communication devices, and includes following steps: receiving, at a wireless communication device, at least a message from a base station, and performing, at the wireless communication device, a random access process according to the at least a message when receiving a paging message with an assigned group paging identifier.

An exemplary embodiment of a group paging method is introduced herein. According to an exemplary embodiment, the group paging method is adapted for a base station to paging a plurality of wireless communication devices, and includes following steps: transmitting, at the base station, at least a message regarding a random access process to distribute the replying of wireless communication devices in a paging group; and transmitting, at the base station, a paging message with an assigned group paging identifier to the wireless communication devices in the same paging group.

An exemplary embodiment of a wireless communication device is introduced herein. According to an exemplary embodiment, the wireless communication device is adapted for responding to group paging of a base station, and includes a transceiver module and a communication protocol module. The transceiver module is configured for transmitting signal to the base station and receiving signal from the base station. The communication protocol module is connected to the transceiver module, and is configured for receiving at least a message from the base station, and performing the random access process according to the at least a message when receiving a paging message with an assigned group identifier.

An exemplary embodiment of a base station is introduced herein. According to an exemplary embodiment, the base station is adapted for paging a plurality of wireless communication devices, and includes a transceiver module and a communication protocol module. The transceiver module is configured for transmitting at least a message regarding a random access process to distribute the replying of wireless communication devices in a paging group, and transmitting a paging message with an assigned group paging identifier to the wireless communication devices in the same paging group.

An exemplary embodiment of a group paging method is introduced herein. According to an exemplary embodiment, the group paging method includes following steps: receiving, at a wireless communication devices, a paging message with a group paging identifier; performing, at the wireless communication device, a predefined mathematical operation on a device identifier of the wireless communication device; determining, at the wireless communication device, a resource opportunity for a random access process according to the result of the predefined mathematical operation; and performing, at the wireless communication device, the random access process at the determined resource opportunity.

An exemplary embodiment of a wireless communication device is introduced herein. According to an exemplary embodiment, the wireless communication device is adapted for replying to a paging message with a group paging identifier, and includes a transceiver module and a communication protocol module. The transceiver module is configured for transmitting signal to the base station and receiving signal from the base station. The communication protocol module is connected to the transceiver module, and is configured for receiving a paging message with a group paging identifier, performing a predefined mathematical operation on a device identifier of the wireless communication device, then determining a resource opportunity according to the result of the predefined mathematical operation, and further performing a random access process at the determined resource opportunity.

An exemplary embodiment of a group paging method is introduced herein. According to an exemplary embodiment, the group paging method is adapted for a paging controller, and includes following steps: grouping a plurality of base stations into different paging areas with associated group paging identifiers; receiving reports of mobility information of the wireless communication devices from a base station; and assigning respectively the group paging identifiers to the wireless communication devices according to their mobility information.

An exemplary embodiment of a paging controller is introduced herein. According to an exemplary embodiment, the paging controller is adapted for group paging a plurality of wireless communication devices, and includes a control module. The control module is connected to a plurality of base stations, and configured for grouping the base stations into different paging areas with associated group paging identifiers, receiving reports of mobility information of the wireless communication devices from a base station, and assigning respectively the group paging identifiers to the wireless communication devices according to their mobility information.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates an example of group paging scheme.

FIG. 2 is functional block diagram of an eNB according to an exemplary embodiment.

FIG. 3 is functional block diagram of a wireless communication device according to an exemplary embodiment.

FIG. 4A is a schematic diagram illustrating a group paging ID arrangement example according to the first exemplary embodiment.

FIG. 4B is a flowchart illustrating a group paging method from a wireless communication device perspective according to a first exemplary embodiment.

FIG. 4C is a flowchart illustrating a group paging method from a base station perspective according to a first exemplary embodiment.

FIG. 4D is a flowchart illustrating a group paging method from a paging controller perspective according to a first exemplary embodiment.

FIG. 5A illustrates an example of confusion situation in group paging.

FIG. 5B is a flowchart illustrating a group paging method from a wireless communication device perspective according to a second exemplary embodiment.

FIG. 5C is a flowchart illustrating a group paging method from a base station perspective according to a second exemplary embodiment.

FIG. 5D is a flowchart illustrating a group paging method from a paging controller perspective according to a second exemplary embodiment.

FIG. 6A is a flowchart illustrating a group paging method from a wireless communication device perspective according to a third exemplary embodiment.

FIG. 6B is a flowchart illustrating a group paging method from a base station perspective according to a third exemplary embodiment.

FIG. 6C is a flowchart illustrating a group paging method from a paging controller perspective according to a third exemplary embodiment.

FIG. 7A is a schematic diagram illustrating the situation when some member(s) in a group do not respond to the group paging according to the third exemplary embodiment.

FIG. 7B is a flowchart illustrating a group paging method from a wireless communication device perspective according to a fourth exemplary embodiment.

FIG. 8A is a schematic diagram illustrating the situation when some member(s) in a group do not respond to the group paging according to the fourth exemplary embodiment.

FIG. 8B is a flowchart illustrating a group paging method from a wireless communication device perspective according to a fifth exemplary embodiment.

FIG. 8C is a flowchart illustrating a group paging method from a base station perspective according to a fifth exemplary embodiment.

FIG. 8D is a flowchart illustrating a group paging method from a paging controller perspective according to a fifth exemplary embodiment.

FIG. 9A is a flowchart illustrating a group paging method from a wireless communication device perspective according to a sixth exemplary embodiment.

FIG. 9B is a flowchart illustrating a group paging method from a base station perspective according to a sixth exemplary embodiment.

FIG. 9C is a flowchart illustrating a group paging method from a paging controller perspective according to a sixth exemplary embodiment.

FIG. 10A a flowchart illustrating a group paging method from a wireless communication device perspective according to a seventh exemplary embodiment.

FIG. 10B is a flowchart illustrating a group paging method from a base station perspective according to a seventh exemplary embodiment.

FIG. 10C is a flowchart illustrating a group paging method from a paging controller perspective according to a seventh exemplary embodiment.

FIG. 11A a flowchart illustrating a group paging method from a wireless communication device perspective according to an eighth exemplary embodiment.

FIG. 11B is a flowchart illustrating a group paging method from a base station perspective according to an eighth exemplary embodiment.

FIG. 11C is a flowchart illustrating a group paging method from a paging controller perspective according to an eighth exemplary embodiment.

FIG. 11D is a schematic diagram illustrating the group paging method according to the eighth exemplary embodiment.

FIG. 12A a flowchart illustrating a group paging method from a wireless communication device perspective according to a ninth exemplary embodiment.

FIG. 12B is a flowchart illustrating a group paging method from a base station perspective according to a ninth exemplary embodiment.

FIG. 12C is a flowchart illustrating a group paging method from a paging controller perspective according to a ninth exemplary embodiment.

FIG. 12D is a schematic diagram illustrating the group paging method according to the ninth exemplary embodiment.

FIG. 13 is a flowchart illustrating a group paging method from a wireless communication device perspective according to a tenth exemplary embodiment.

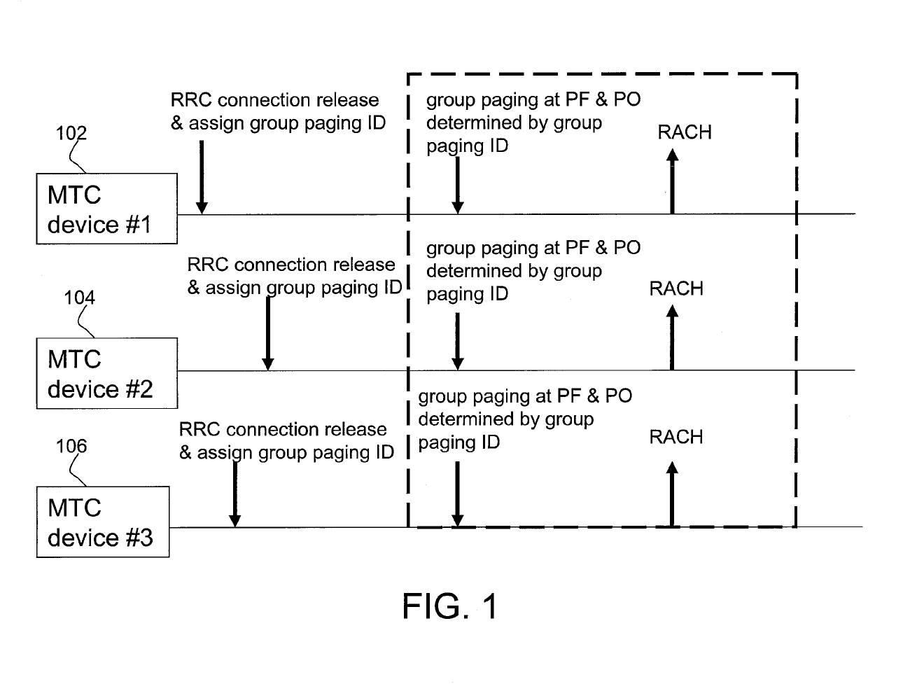

### DESCRIPTION OF THE EXEMPLARY EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

In the present disclosure, there is proposed a group paging method, which can be applied in wireless communication system within which the wireless communication devices can be grouped or classified into different groups according to device capabilities, such as device mobility, applications, location and etc. The present disclosure is not limited to the MTC device, and the proposed group paging method could also be applied to wireless communication device(s) which are MTC devices and H2H devices. The present disclosure provides various embodiments which can effectively enhance the performance of group paging process as well as achieve less network overhead and lower collision rate in random access process.

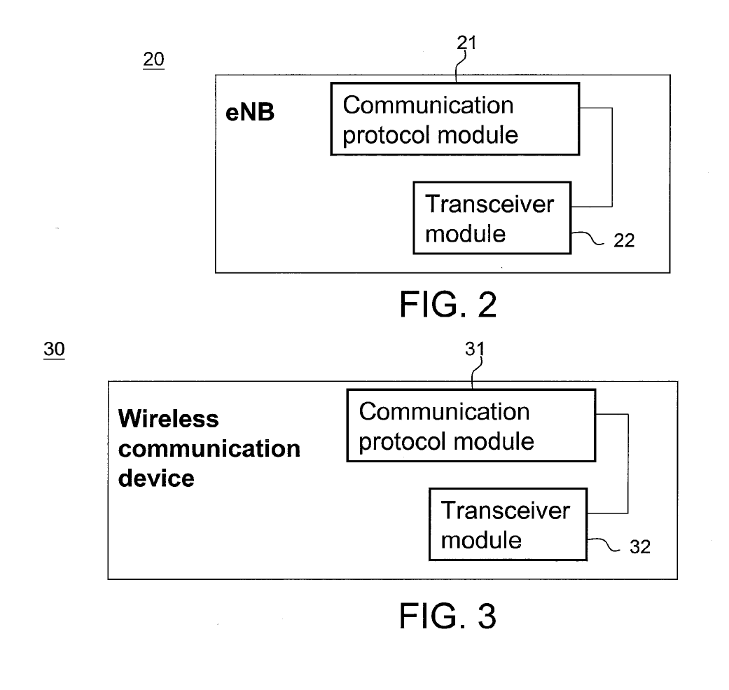

In the present disclosure, there are also base stations and wireless communication devices proposed along with the group paging methods. FIG. 2 is functional block diagram of an eNB according to an exemplary embodiment. Throughout the present disclosure, the eNB can represent a base station, or an advanced base station (ABS). Further, in some embodiments, a paging controller can control one or more base stations for performing their paging processes, and the paging controller may co-locate with mobility management entity (MME) within the wireless communication system.

For example, the paging controller can include a control module, which is connected to a plurality of base stations, and configured for grouping the base stations into different paging areas with associated group paging identifiers, receiving reports of mobility information of the wireless communication devices from a base station, and assigning respectively the group paging identifiers to the wireless communication devices according to their mobility information. Further, when the wireless communication devices of the paging group are determined being mobile, the control module assigns a first group paging identifier; and when the wireless communication devices of the paging group are determined being of fixed position, the control module assigns a second group paging identifier. Further, when the paging controller intends to page a wireless communication device with the first group paging identifier, the control module requests the base stations in a first paging area to make the group paging. In addition, when the paging controller intends to page the wireless communication device with the second group paging identifier, the control module requests only one base station in a second paging area to make the group paging.

Referring to FIG. 2, the eNB 20 includes at least a communication protocol module 21 and a transceiver module 22. The communication protocol module 21 is connected to the transceiver module 22. Moreover, the eNB 20 can also include other components such as antenna modules, memory modules, or processor modules for transmitting and receiving radio frequency (RF) signals as well as performing relevant calculations or determinations.

The transceiver module 22 is configured for transmitting RF signals to the wireless communication device(s) within its radio coverage as well as receiving RF signals from the aforementioned wireless communication device(s). Throughout the present disclosure, the term “downlink” refers to the RF signal transmission from an eNB to a wireless communication device within the radio coverage of the eNB; the term “uplink” refers to the RF signal transmission from a wireless communication device to its eNB.

The communication protocol module 21 is configured for broadcasting or multicasting group paging to a group of wireless communication device(s) within the radio coverage of the eNB 20, or performing a normal paging on a specific wireless communication device. Also, the communication protocol module 21 is also configured for forwarding relevant messages, information, or indication to the aforementioned wireless communication device(s). Further, the eNB 20 can include other components such as a network interface module (not shown) for connecting with a paging controller (or a network server), providing information to the paging controller and receiving requests or control signaling from the paging controller. In addition, the eNB 20 can include a processor module (not shown) for coordinating the aforementioned network interface module, the communication protocol module 21 and the transceiver module 22.

FIG. 3 is functional block diagram of a wireless communication device according to an exemplary embodiment. Throughout the present disclosure, the wireless communication device can represent a mobile station, an user equipment (UE), an advanced mobile station (AMS), or a MTC device. Referring to FIG. 3, the wireless communication device 30 includes at least a communication protocol module 31 and a transceiver module 32. The communication protocol module 31 is connected to the transceiver module 32. Moreover, the wireless communication device 30 can also include other components such as antenna modules, memory modules, or processor modules for transmitting and receiving radio frequency (RF) signals as well as perform relevant calculations or determinations.

The transceiver module 32 is configured for transmitting RF signals to its eNB (or the access base station) as well as receiving RF signals from the eNB. The communication protocol module 31 is configured for providing its device capability to the eNB of the wireless communication device 30. Also, the communication protocol module 31 is configured for determining its group paging identifier (ID) from message delivered from the eNB, as well as determining the RACH (opportunity) at which the wireless communication device 30 should perform RACH attempts. Moreover, the communication protocol module 31 is also configured for carry out relevant mathematical operations (or calculations) and initiate timer(s) associated with the RACH process. In addition, the wireless communication device 30 can include other components such as a processor module (not shown) for coordinating the aforementioned communication protocol module 31 and the transceiver module 32.

In conventional group paging techniques, a wireless communication device receives paging from an eNB while the paging controller requests the eNBs to page that wireless communication device within a tracking area (TA), where a TA can include a plurality of eNBs. Considering a MTC device with a fixed location (which also means the MTC device is not mobile) such as a smart electricity meter, usually such MTC device does not necessarily need a TA-based paging approach. Thus, in the first exemplary embodiment, the wireless communication devices can be grouped into at least two groups regarding their device capability (typically the device mobility), where the first group includes mobile MTC devices, and the second group includes fixed location MTC devices.

Also, group paging identifiers are specified for or assigned to MTC devices. Different group paging identifiers have different paging area. The paging controller respectively records the group paging identifiers to which a specific MTC device belong and further identify which corresponding eNB should be involved in the respective paging area, and then request the corresponding eNB to perform paging if the paging controller intends to find that specific MTC device. In a particular implementation of the first exemplary embodiment, the group paging identifiers can be classified into two pools, where the first pool of the group paging identifiers can be assigned to the fixed location MTC devices, and the second pool of the group paging identifiers can be assigned to the mobile MTC devices.

The aforementioned group paging approach can be extended to cover the situations for more than two pools and more than two groups, and can be also extended to cover the situation where MTC devices and H2H devices are all operating in the same wireless communication system.

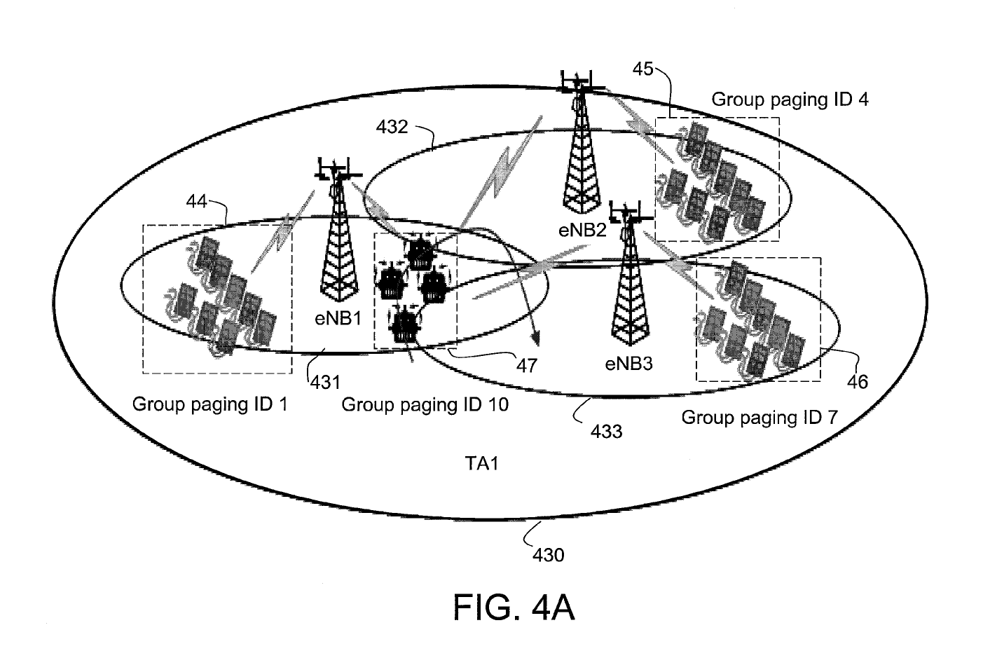

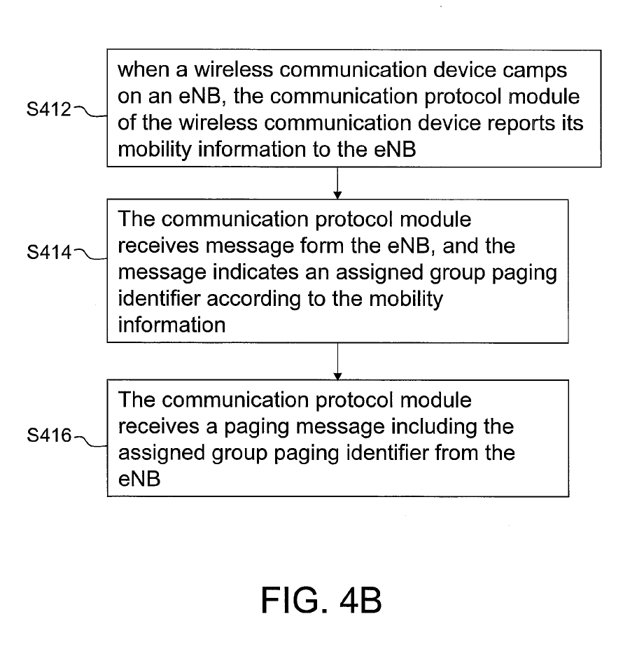

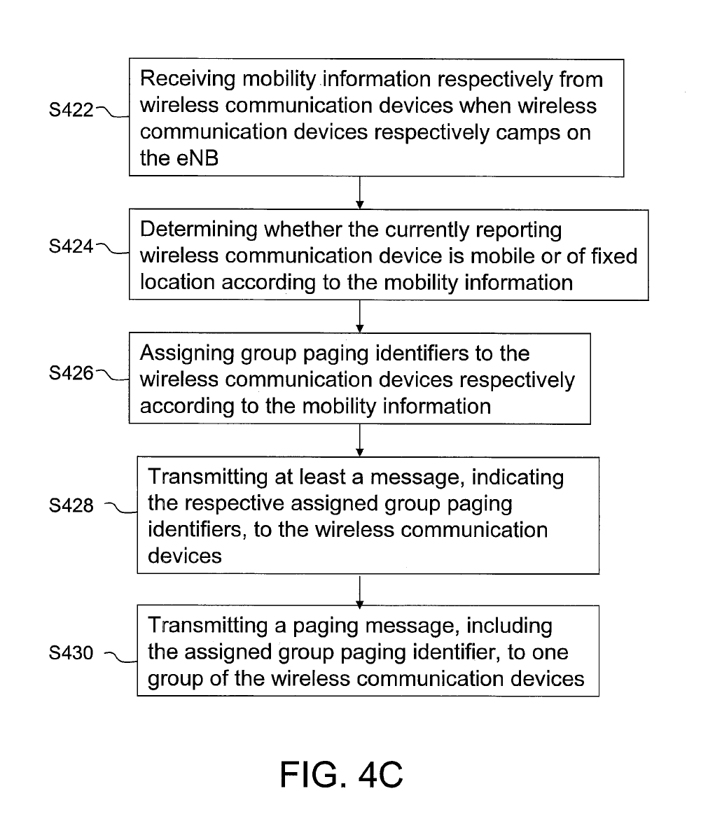

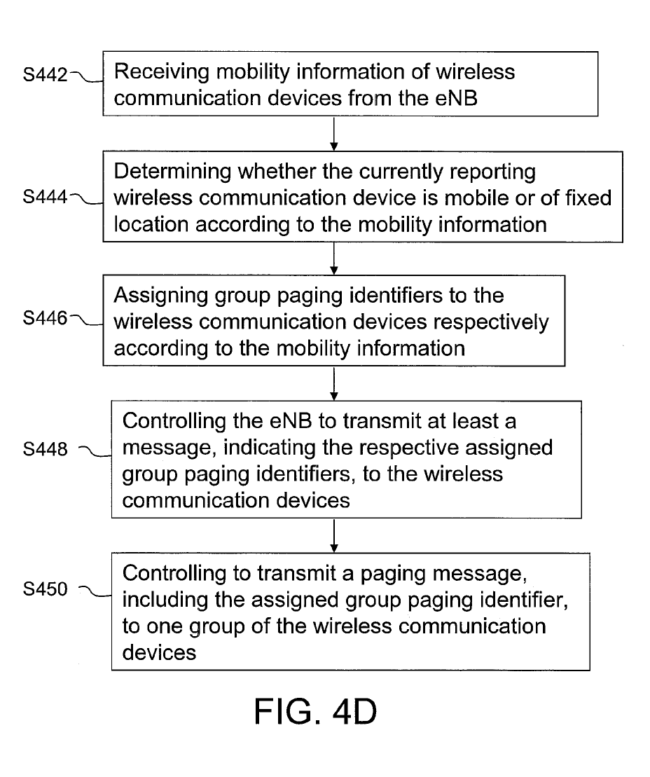

The group paging method in the first exemplary embodiment can further be explained in accordance with FIG. 4A. FIG. 4A is a schematic diagram illustrating a group paging ID arrangement example according to the first exemplary embodiment. Referring to FIG. 4A, in this exemplary diagram, eNB1, eNB2, and eNB3 are in the same TA1. The areas enclosed by ellipses 430, 431, 432, 433 respectively represent the radio coverage of the TA1, the eNB1, the eNB2 and the eNB3. Also, the MTC devices enclosed in dashed lines 44, 45, 46 respectively represent the fixed location MTC devices which are assigned with group paging IDs 1, 4, 7. The MTC devices enclosed in a dashed line 47 represent the mobile MTC devices, which are assigned with group paging ID 10. In other words, group paging IDs are partitioned into different pools when arranging the group paging IDs to wireless communication devices. In addition, the group paging IDs are assigned respectively to the wireless communication devices according to their device mobility.

Referring to FIG. 4A, the group paging IDs are categorized into two pools where group paging IDs 1-9 (also referring to Table I below) are allocated for fixed MTC devices and group paging IDs 10-12 are just allocated for mobile MTC devices. The group paging IDs 1-9 are further divided into three sets which are mapped to different eNBs, where the group paging IDs 1-3 are mapped to the eNB1, the group paging IDs 4-6 are mapped to the eNB2, and the group paging IDs 7-9 are mapped to the eNB3. For example, when a MTC device enclosed in dashed line 44 sends the device capability to eNB1, eNB1 will forward that message to the network server (the network server can represent as a paging controller). Then, the network server could determine that the device capability of the MTC device is not mobile and the message was from eNB1, then the group paging ID1 was appropriate to assign to that MTC device. Therefore, the network server will request eNB1 to assign the group paging ID1 to that MTC device.

According to the Table I and appropriate assignment, when network server (or paging controller, or an eNB) wants to paging a group of fixed MTC devices, only one corresponding eNB is involved and this can eliminate overhead other eNBs. For example, when it is required to group paging the fixed MTC devices assigned with group paging ID 1, only the eNB1 is required to perform the group paging while the eNB2 and the eNB3 do not participate in the group paging process.

TABLE I

| | eNB1 | eNB2 | eNB3 |
|---|---|---|---|
| Fixed pool | 1, 2, 3 | 4, 5, 6 | 7, 8, 9 |

| | |
|---|---|
| Mobile pool | 10, 11, 12 |

On the other hand, for a group of mobile MTC devices, all three eNBs shown in FIG. 4A are involved to deliver group paging message and this approach facilitates MTC devices which do not need to perform location registration when crossing the radio coverage of those eNBs.

FIG. 4B is a flowchart illustrating a group paging method from a wireless communication device perspective according to a first exemplary embodiment. Referring to FIG. 4B, the group paging method from the wireless communication device perspective starts from step S412. In the step S412, when a wireless communication device 30 camps on an eNB 20, the communication protocol module 31 of the wireless communication device 30 reports its mobility information to the eNB 20 regarding its own mobility capability. That is, the mobility information indicates whether the wireless communication device 30 is mobile or of fixed location. In step S414, the communication protocol module 31 receives a message form the eNB 20, where the message indicates an assigned group paging identifier according to the mobility information.

In step S416, the communication protocol module 31 receives a paging message including the assigned group paging identifier from the eNB 20. The group paging method from the wireless communication device perspective is terminated after the step S416.

FIG. 4C is a flowchart illustrating a group paging method from a base station perspective according to a first exemplary embodiment. Referring to FIG. 4C, the group paging method from the base station perspective starts from step S422. In the step S422, the communication protocol module 21 of the eNB 20 receives mobility information respectively from wireless communication devices when the wireless communication devices respectively camps on the eNB 20.

In step S424, the communication protocol module 21 determines whether the currently reporting wireless communication device is mobile or of fixed location according to the mobility information. In other words, the mobility information indicates the currently reporting wireless communication device is mobile or of fixed location.

In the step S426, the communication protocol module 21 assigns group paging identifiers to the wireless communication devices respectively according to the mobility information. If a wireless communication device is determined being mobile in the step S424, the communication protocol module 21 assigns a group paging identifier for the mobile MTC devices to the wireless communication device. On the contrary, if another wireless communication device is determined being of fixed location in the step S424, then the communication protocol module 21 assigns another group paging identifier for the fixed location MTC devices to this wireless communication device.

In the step S428, the communication protocol module 21 transmits at least a message, indicating the respective assigned group paging identifiers, to the wireless communication devices.

In the step S430, the communication protocol module 21 transmits a paging message, including the assigned group paging identifier, to one group of the wireless communication devices. After the step S430, the group paging method from the base station perspective is terminated.

When the currently reporting wireless communication device is determined being mobile, then the eNB is partitioned by a paging controller into a first paging area with other base stations. Also, when the currently reporting wireless communication device is determined being of fixed position, then the eNB is partitioned by the paging controller into a second paging area without other base stations. Further, when the communication protocol module 21 intends to page a group of wireless communication devices which are mobile in the step S430, other base stations in the first paging area also make the paging for the group of wireless communication devices. On the contrary, when the communication protocol module 21 intends to page a group of wireless communication devices which are of fixed position, just the communication protocol module 21 in the second paging area makes the paging.

FIG. 4D is a flowchart illustrating a group paging method from a paging controller perspective according to a first exemplary embodiment. Referring to FIG. 4D, the group paging method from the paging controller perspective starts from step S442. In the step S442, the paging controller acquires mobility information of wireless communication devices the eNB 20. In step S444, the paging controller determines whether the currently reporting wireless communication device is mobile or of fixed location according to the mobility information. In other words, the mobility information indicates the currently reporting wireless communication device is mobile or of fixed location.

In the step S446, the paging controller assigns group paging identifiers to the wireless communication devices respectively according to the mobility information. If a wireless communication device is determined being mobile in the step S444, the paging controller assigns the wireless communication device a group paging identifier for the mobile MTC devices. On the contrary, if another wireless communication device is determined being of fixed location in the step S444, then the paging controller assigns this wireless communication device another group paging identifier for the fixed location MTC devices.

In the step S448, the paging controller controls the eNB 20 to transmit at least a message, indicating the respective assigned group paging identifiers, to the wireless communication devices. In the step S450, the paging controller controls the eNB 20 to transmit a paging message, including the assigned group paging identifier, to one group of the wireless communication devices. After the step S450, the group paging method from the paging controller perspective is terminated.

When the currently reporting wireless communication device is determined being mobile, then the eNB is partitioned by a paging controller into a first paging area with other base stations. Also, when the currently reporting wireless communication device is determined being of fixed position, then the eNB is partitioned by the paging controller into a second paging area without other base stations. Further, when the paging controller intends to page a group of wireless communication devices which are mobile in the step S430, paging controller simultaneously control other base stations in the first paging area to make the paging for the group of wireless communication devices. On the contrary, when the paging controller intends to page a group of wireless communication devices which are of fixed position, the paging controller just controls the communication protocol module 21 in the second paging area to make the paging.

Although the first exemplary embodiment provides a group paging method which involves less eNBs when paging a group of fixed location MTC devices, the MTC devices which receive the same paging message may perform the RACH attempts at the same time, which results in RACH collision.

In legacy operation, the network server or the paging controller can continue paging a wireless communication device until the wireless communication device made responses or a pre-defined timer (e.g., a timer T1) expires. A wireless communication device can forward its UE identity (e.g., S-TMSI) to the network server or the paging controller when the wireless communication device has received its associated paging message and the paging process will be finished after the report. For group paging, a wireless communication device can forward group paging ID to the network server or the paging controller, and the network server or the paging controller can then calculate (or check as shown as step S504) how many reporting it receives from wireless communication devices of the same paging group, in order to check whether all members in the same paging group is responded or not.

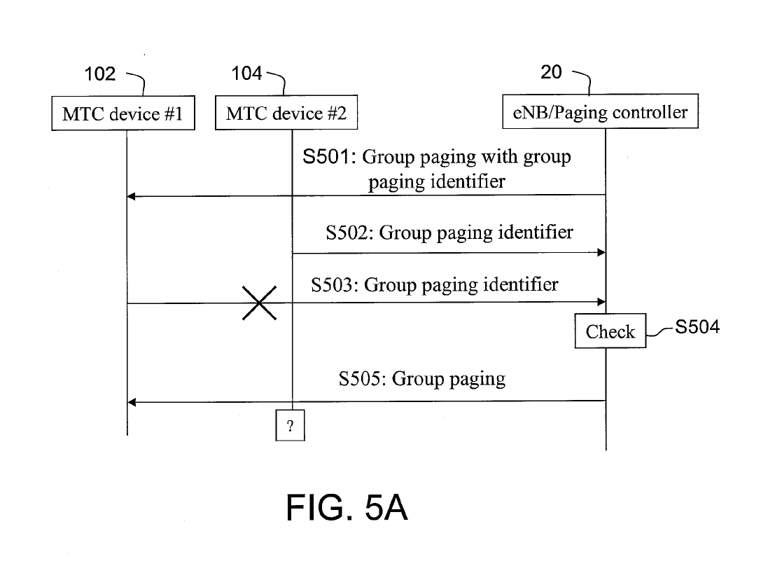

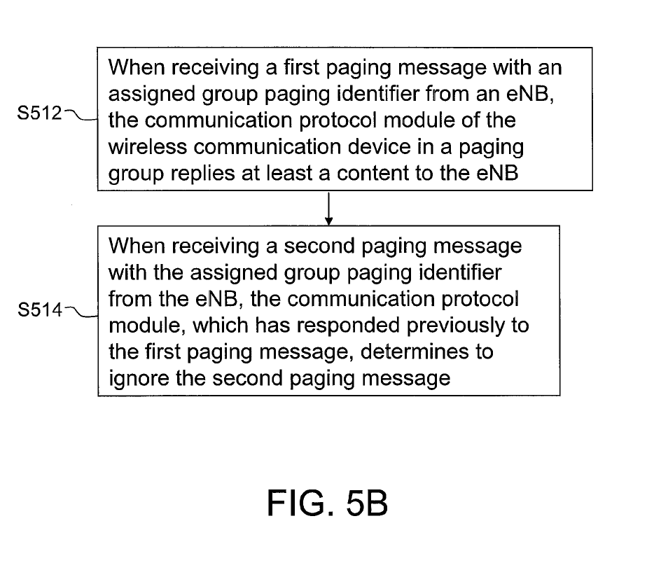

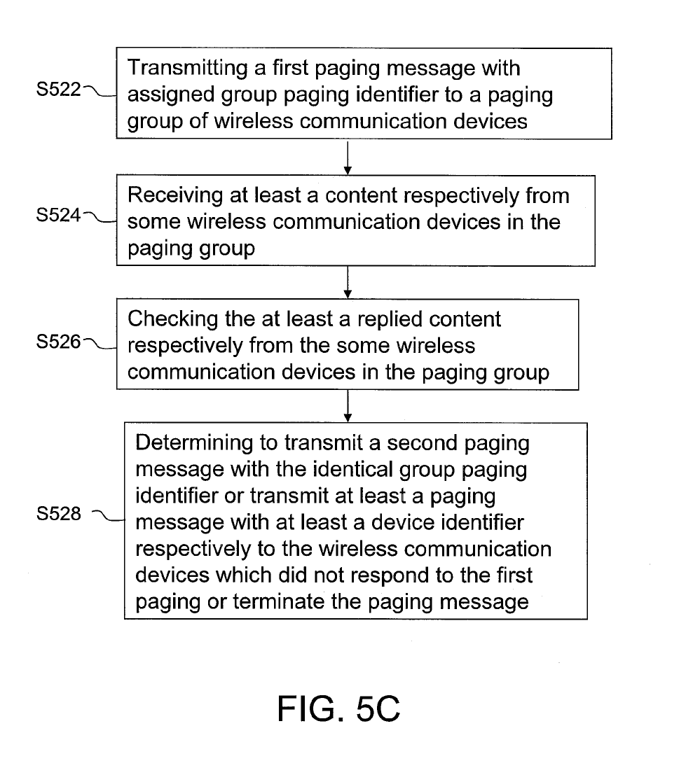

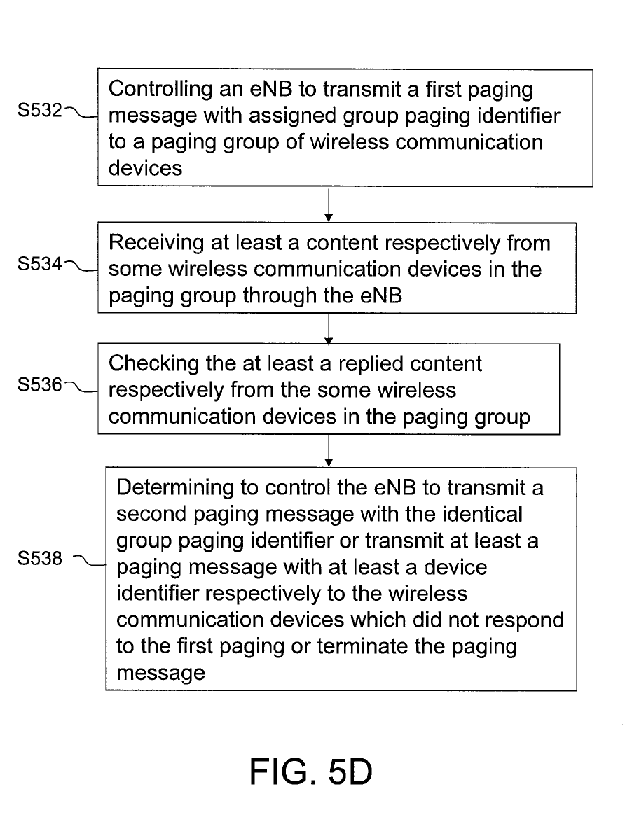

However, as shown in FIG. 5A, FIG. 5A illustrates an example of confusion situation in group paging. After the eNB 20 receives paging command from a paging controller and delivers the group paging with group paging ID in step S501, when only MTC device #2 (labeled as 104) successfully reports back its group identity in step S502, but another MTC device #1 (labeled as 102) does not respond for regarding group paging (the reason may be RACH attempt collision, or bad link connection as shown in step S503), then the network server (or the eNB 20, or the paging controller) can continue paging the same group. This repeated group paging can easily confuse other previously responded MTC devices (like MTC device #2) in the same group (since they may treat this group paging is for another event and make response to the same group paging again). Therefore, in order to avoid this confusion, there are proposed three different embodiments below.

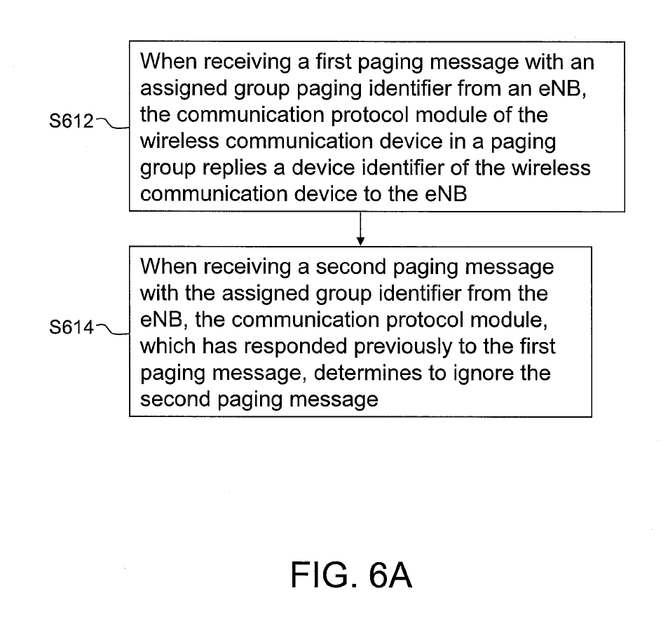

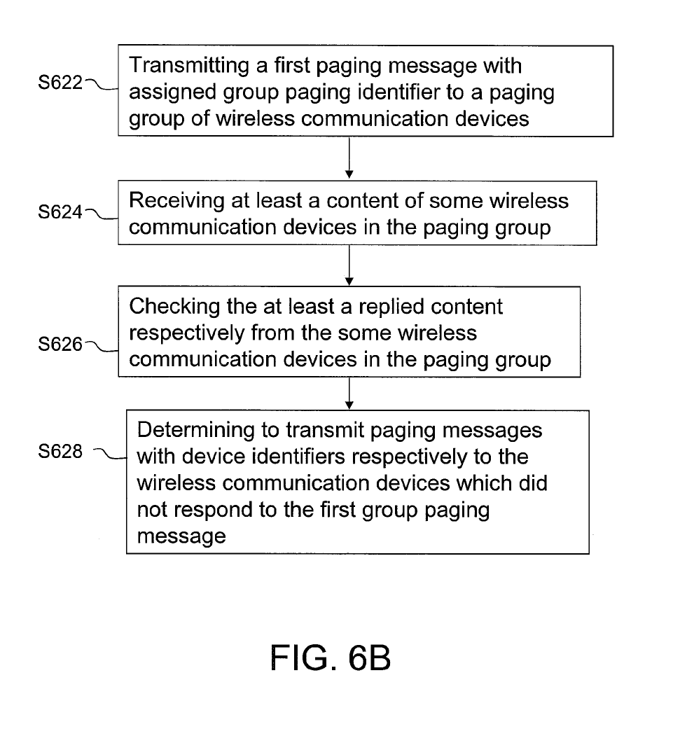

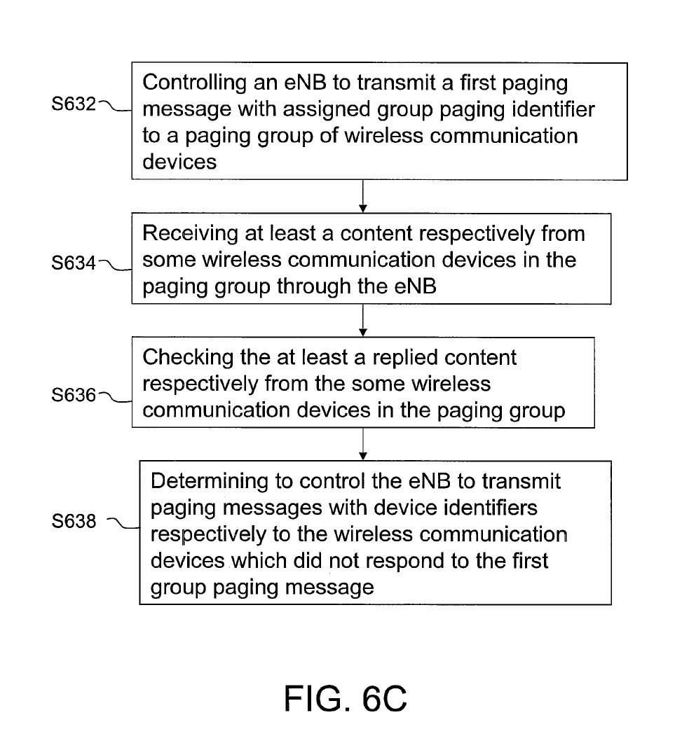

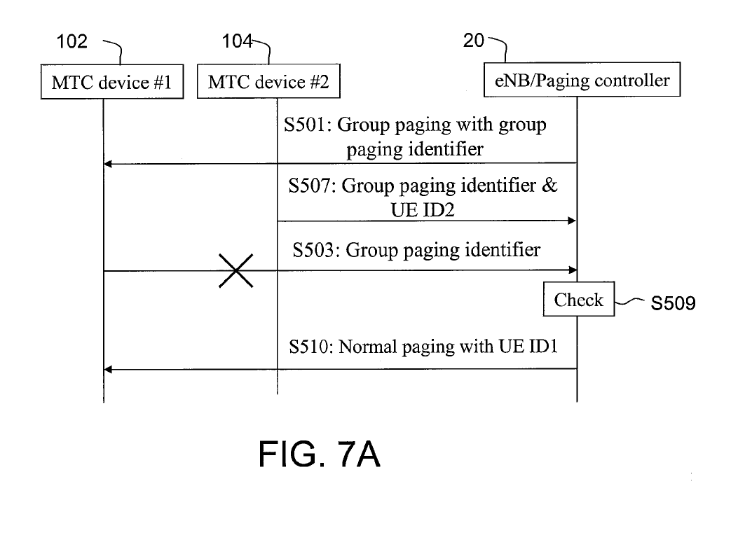

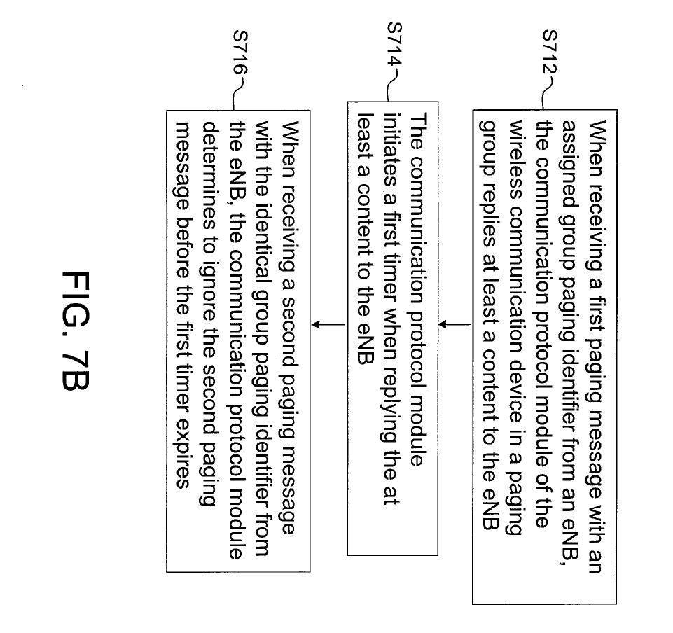

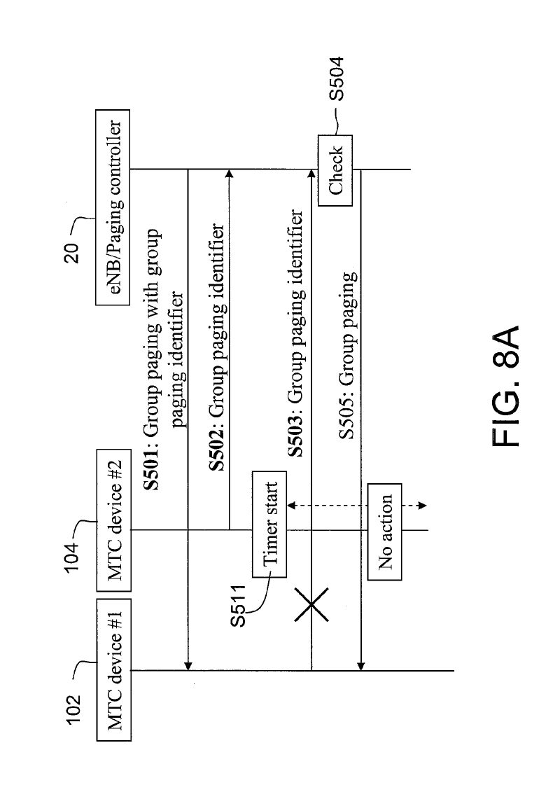

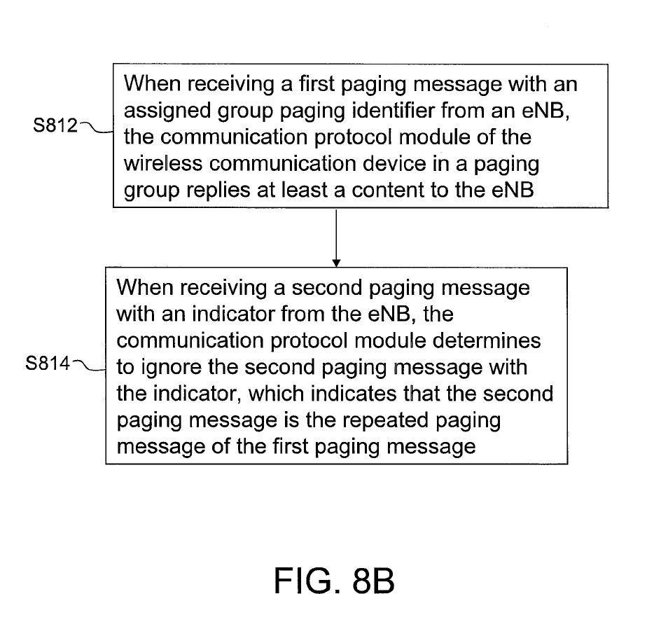

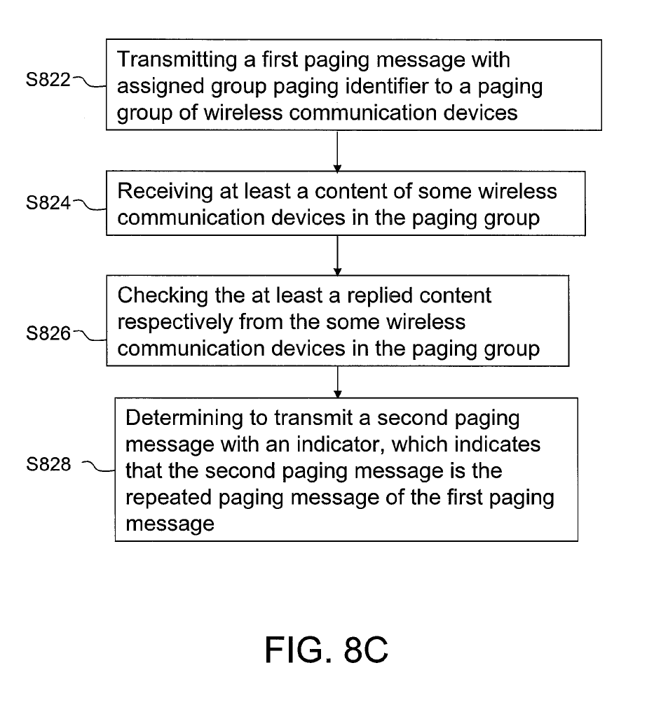

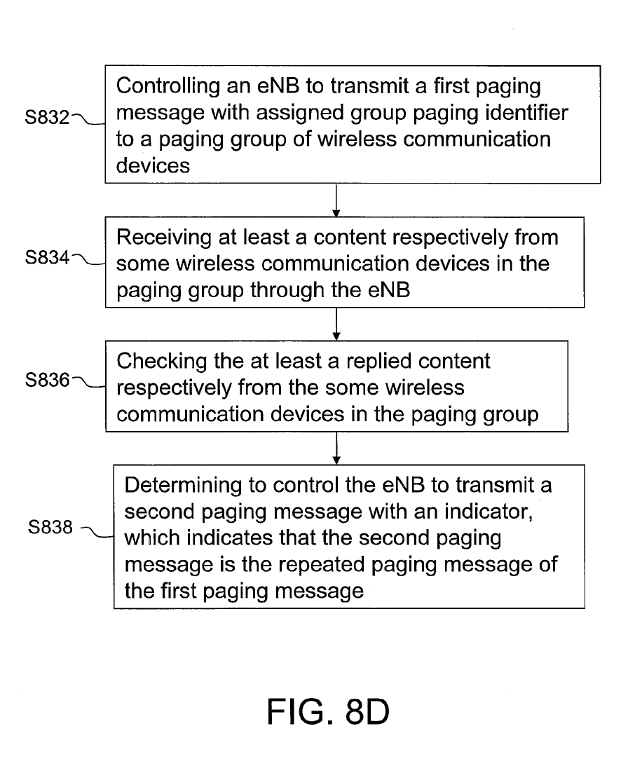

FIG. 5B is a flowchart illustrating a group paging method from a wireless communication device perspective according to a second exemplary embodiment. The second exemplary embodiment provides a generic flowchart which covers the embodiments illustrated in following FIG. 6A, FIG. 7B and FIG. 8B. The group paging method from the wireless communication device perspective of the second exemplary embodiment starts from step S512. In the step S512, when the communication protocol module 31 of the wireless communication device 30 receives a first paging message with an assigned group paging identifier from an eNB 20, the communication protocol module 31 of the wireless communication device 30 in a paging group replies at least a content to the eNB 20.

In step S514, when the communication protocol module 31 receives a second paging message with the assigned group paging identifier from the eNB 20, the communication protocol module 31, which has responded previously to the first paging message, determines to ignore the second paging message. The group paging method from the wireless communication device perspective is terminated after the step S514.

FIG. 5C is a flowchart illustrating a group paging method from a base station perspective according to a second exemplary embodiment. FIG. 5C provides a generic flowchart which covers the embodiments illustrated in following FIG. 6B, FIG. 7C and FIG. 8C. Referring to FIG. 5C, the group paging method from the base station perspective of the second exemplary embodiment starts from step S522. In the step S522, the communication protocol module 21 of the eNB 20 transmits a first paging message with assigned group paging identifiers respectively to a paging group of wireless communication devices. In step S524, the communication protocol module 21 receives at least a content respectively from some wireless communication devices in the paging group. In step S526, the communication protocol module 21 checks the at least a replied content respectively from the some wireless communication devices in the paging group.

In step S528, according to the check result in the step S526, the communication protocol module 21 determines to transmit a second paging message with the identical group paging identifier or transmit at least a paging message with at least a device identifier respectively to the wireless communication devices, which did not respond to the first paging. Alternatively, in the step S528, the communication protocol module 21 determines to terminate the paging message according to the check result in the step S526. The group paging method from the base station perspective is terminated after the step S528.

FIG. 5D is a flowchart illustrating a group paging method from a paging controller perspective according to a second exemplary embodiment. Referring to FIG. 5D, the group paging method from the paging controller perspective of the second exemplary embodiment starts from step S532. In the step S532, the paging controller controls the eNB 20 to transmit a first paging message with assigned group paging identifiers respectively to a paging group of wireless communication devices. The verb of “controls” can also refer to “requests” hereinafter throughout the present disclosure. In the step S534, the paging controller receives, through the eNB 20, at least a content respectively from some wireless communication devices in the paging group. In the step S536, the paging controller checks the at least a replied content respectively from the some wireless communication devices in the paging group.

In step S538, according to the check result in the step S536, the paging controller determines to control the eNB 20 to transmit a second paging message with the identical group paging identifier or transmit at least a paging message with at least a device identifier respectively to the wireless communication devices, which did not respond to the first paging or terminate the paging. The group paging method from the paging controller perspective is terminated after the step S538.

FIG. 6A is a flowchart illustrating a group paging method from a wireless communication device perspective according to a third exemplary embodiment. Referring to FIG. 6A, the group paging method from the wireless communication device perspective of the third exemplary embodiment starts from step S612. In the step S612, when the communication protocol module 31 of the wireless communication device 30 receives a first paging message with an assigned group paging identifier from an eNB 20, the communication protocol module 31 of the wireless communication device 30 in a paging group replies at least a content to the eNB 20, where the at least a content is a device identifier of the wireless communication device 30.

The step S614 is similar to the step S514, so the detailed technical contents thereof are not repeated herein. The group paging method from the wireless communication device perspective of the third exemplary embodiment is terminated after the step S614.

FIG. 6B is a flowchart illustrating a group paging method from a base station perspective according to a third exemplary embodiment. Referring to FIG. 6B, the group paging method from the base station perspective of the third exemplary embodiment starts from step S622. The step S622 to step S626 are respectively similar to the step S522 to the step S526, so the technical contents thereof are not repeated herein.

In step S628, according to the check result in the step S626, the communication protocol module 21 determines to transmit paging messages with device identifiers respectively to the wireless communication devices, which did not respond to the first group paging message. The group paging method from the base station perspective is terminated after the step S628.

FIG. 6C is a flowchart illustrating a group paging method from a paging controller perspective according to a third exemplary embodiment. Referring to FIG. 6C, the group paging method from the paging controller perspective of the third exemplary embodiment starts from step S632. The step S632 to step S636 are respectively similar to the step S532 to the step S536, so the technical contents thereof are not repeated herein.

In step S638, according to the check result in the step S636, the paging controller determines to control the eNB 20 to transmit paging messages with device identifiers respectively to the wireless communication devices which did not respond to the first group paging. The group paging method from the paging controller perspective is terminated after the step S638.

FIG. 7A is a schematic diagram illustrating the situation when some member(s) in a group do not respond to the group paging according to the third exemplary embodiment. Referring to FIG. 7A, the eNB performs the group paging with group paging ID (step S501). When the wireless communication device 30 (the MTD device #2 (labeled as 104)) receives a group paging message which records its group paging ID from the eNB 20, the wireless communication device 30 can reply (or forward) its individual UE ID (shown as UE ID2 in FIG. 7A) to the network server (or the eNB 20) (shown in step S507). A timer, T2, in the network server (or in the communication protocol module 21 of the eNB 20) starts after transmitting the group paging message. Another MTC device #1 (labeled as 102) does not respond to the previous group paging (the reason may be RACH attempt collision or bad link connection as shown in step S503).

The network server (or the communication protocol module 21 of the eNB 20) can check which wireless communication device does not make response when the timer T2 expires. Based on the results, the network server (or the paging controller, or the communication protocol module 21 of the eNB 20) can deliver a normal paging message which records un-responded UE ID (shown as UE ID1 in step S510). Also, the previously responded MTC device (the MTC device #2) do not receive the group paging message with group paging ID again during the period of the normal paging process.

FIG. 7B is a flowchart illustrating a group paging method from a wireless communication device perspective according to a fourth exemplary embodiment. Referring to FIG. 7B, the group paging method from a wireless communication device perspective of the fourth exemplary embodiment starts from step S712. The step S712 is similar to the step S512, so the technical content thereof is not repeated herein. In step S714, the communication protocol module 31 of the wireless communication device 30 initiates a timer T3, when the wireless communication device 30 makes a successful reply. That is, the communication protocol module 31 initiates the first timer when replying the at least a content to the eNB 20. It is noted that the duration before the timer T3 expires is configured to be equal to or longer than the pre-defined timer T1 as mentioned previously.

In step S716, the communication protocol module 31 determines to ignore the second paging message before the first timer expires when communication protocol module 31 receives a second paging message with the identical group paging identifier from the eNB 20. That is, the communication protocol module 31 of the wireless communication device 30, which has responded previously to the same group paging determines to ignore the repeated group paging before the timer T3 expires. The group paging method is terminated after the step S716. Oppositely, for those wireless communication devices which were not responded previously to the same group paging, they would determine to reply the second paging message.

FIG. 8A is a schematic diagram illustrating the situation when some member(s) in a group do not respond to the group paging according to the fourth exemplary embodiment. Referring to FIG. 8A, firstly, a wireless communication device 30 receives a group paging message which records its group paging ID (shown in the step S501), the wireless communication device 30 can reply or forward the group paging ID to the network server or the paging controller or the eNB 20 (shown in the step S502) and initiate a timer, T3 after the reply is successful (shown in the step S511). The duration before this timer T3 expires can be set equal to or greater than the duration before the timer T1 expires.

Another MTC device #1 (labeled as 102) does not respond to the group paging (the reason may be RACH attempt collision or bad link connection as shown in the step S503). The network server (or the paging controller, or the communication protocol module 21 of the eNB 20) can check which wireless communication device(s) do not make response to the group paging when the timer T2 expires (shown in the step S504). Based on the results, the network server (or in the communication protocol module 21 of the eNB 20) can deliver the same group paging message which records the same group paging ID (shown in step S505).

When another paging message which records the same group paging ID is received by the wireless communication device 30 before the timer T3 expires, the wireless communication device 30 previously responding to the previous group paging can ignore the repeated group paging until the T3 expires. It is also noted that the aforementioned paging operation just applies to the group paging, a wireless communication device have to respond to a normal paging message which records its UE ID before the timer T3 expires even it just responds to a previous group paging message which records its group paging ID.

FIG. 8B is a flowchart illustrating a group paging method from a wireless communication device perspective according to a fifth exemplary embodiment. The group paging method from the wireless communication device perspective of the fifth exemplary embodiment starts from step S812. The step S812 is similar to the step S512, so the detailed technical content thereof is not repeated herein.

In step S814, when the communication protocol module 31 of the wireless communication device 30 receives a second paging message with an indicator from the eNB, the communication protocol module 31, which has responded to the previous first paging message, determines to ignore the second paging message with the indicator. The indicator indicates that the second paging message is the repeated paging message of the first paging message. Also, the indicator can be a mark field (one bit long) added to the paging message, and the indicator can also indicate that the another group paging message is the repeated group paging message of the previous group paging message. Oppositely, for those wireless communication devices which were not responded previously to the same group paging, they would determine to reply to the second paging message. The group paging method from the wireless communication device perspective is terminated after the step S814.

It is also noted that the third exemplary embodiment, the fourth exemplary embodiment, and the fifth exemplary embodiment can be combined to form different embodiments depending upon practical system requirements. For example, a wireless communication device can report its individual device identifier when receive group paging, when there are a lot of non-responded wireless communication devices, the network server (or the eNB or the paging controller) can deliver a repeated group paging message with the identical group paging identifier, meanwhile a timer or a mask can be also applied to avoid confusion for the previously responded wireless communication device.

FIG. 8C is a flowchart illustrating a group paging method from a base station perspective according to a fifth exemplary embodiment. Referring to FIG. 8C, the group paging method from the base station perspective of the fifth exemplary embodiment starts from step S822. The step S822 to step S826 are respectively similar to the step S522 to the step S526, so the technical contents thereof are not repeated herein.

In step S828, according to the check result in the step S826, the communication protocol module 21 of the eNB 20 determines to transmit the second paging message with an indicator, which indicates that the second paging message is the repeated paging message of the first paging message. The group paging method from the base station perspective is terminated after the step S828.

FIG. 8D is a flowchart illustrating a group paging method from a paging controller perspective according to a fifth exemplary embodiment. Referring to FIG. 8D, the group paging method from the paging controller perspective of the fifth exemplary embodiment starts from step S832. The step S832 to step S836 are respectively similar to the step S532 to the step S536, so the technical contents thereof are not repeated herein.

In step S838, according to the check result in the step S836, the paging controller determines to control the eNB 20 to transmit the second paging message with an indicator, which indicates that the second paging message is the repeated paging message of the first paging message. The group paging method from the paging controller perspective is terminated after the step S838.

In conventional, a wireless communication device immediately performs RACH attempt to contact with an eNB when receiving a paging message. There is no specification on which RACH (opportunity) a wireless communication device should perform the RACH attempt, but always the incoming first RACH opportunity. However, if the number of members in a paging group is large, a lot of wireless communication devices can access to RACH at the same time and this results in an increase on the collision rate. This situation can further force the network server (or the eNB or the paging controller) to continue the group paging (due to no successful response from all wireless communication devices) and thus increase huge network loading.

Also, normal H2H devices can be influenced when performing their respective RACH attempts at the same time. Limiting the number of members in a paging group can be a solution, but many paging groups are still required and it can be difficult to manage and control when the number of paging groups is large. In order to resolve the aforementioned issue, there are five embodiments proposed to diverge the RACH attempts of wireless communication devices (belonging to the same paging group) after they receive the group paging.

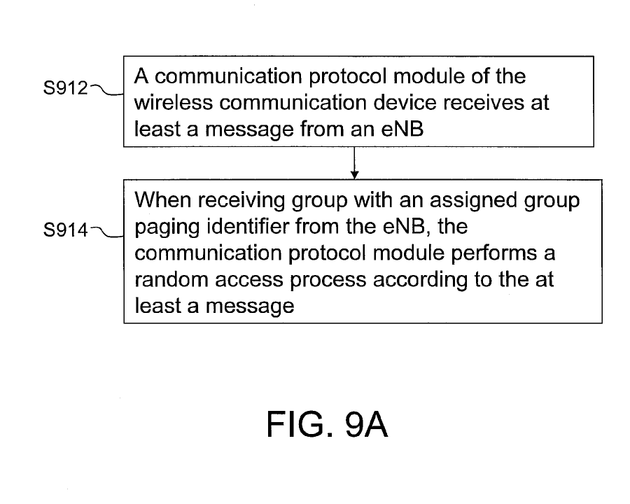

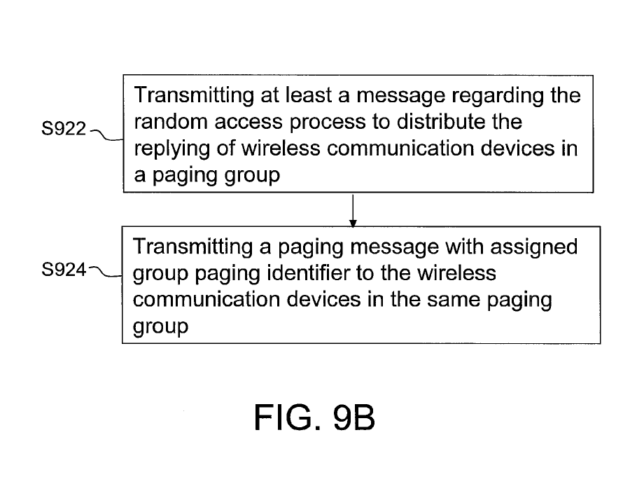

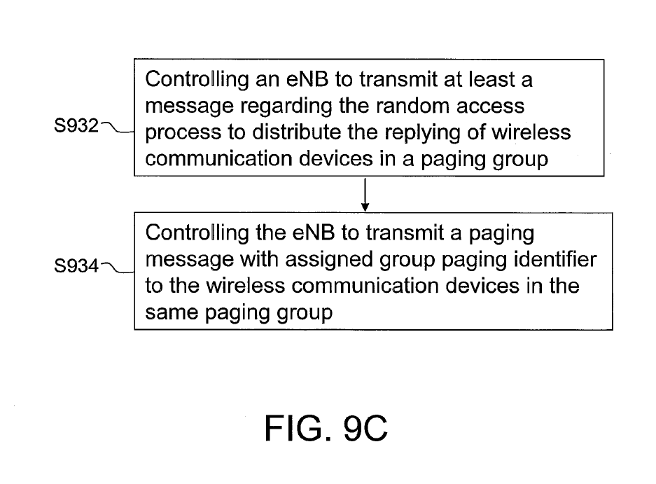

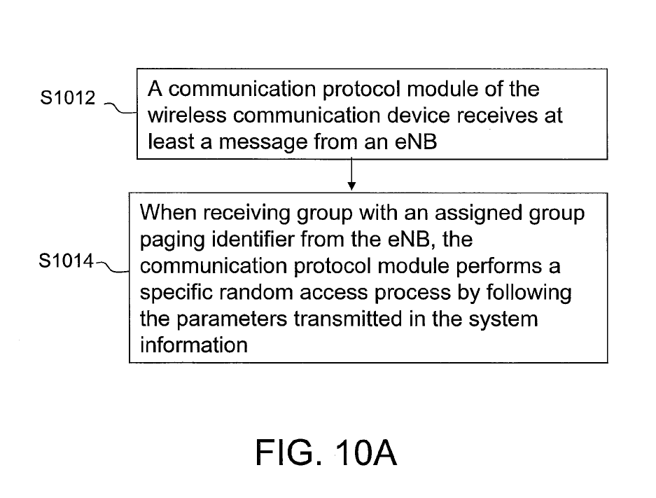

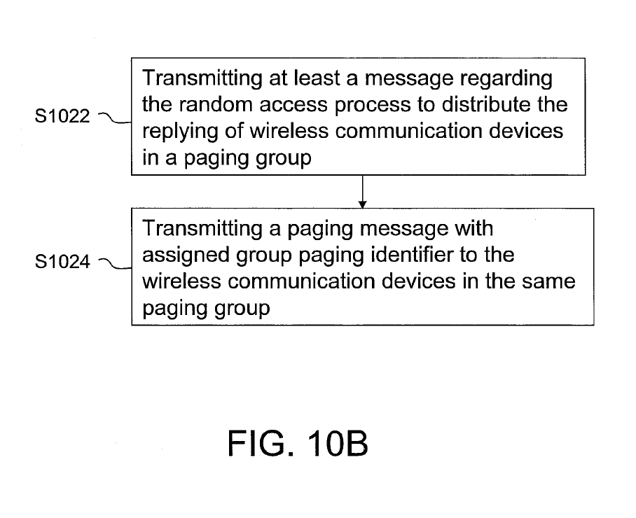

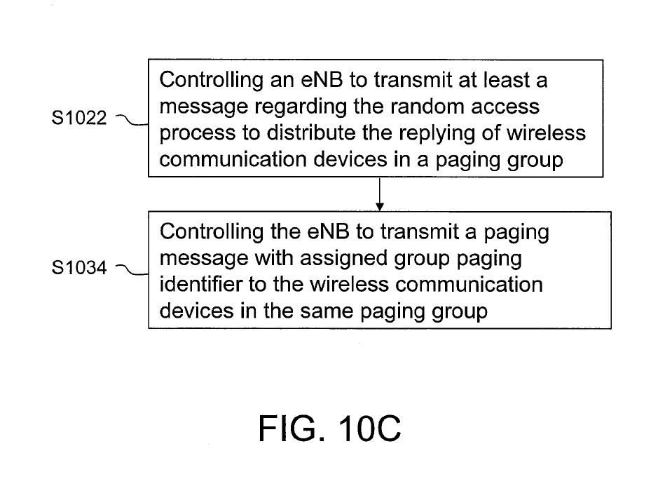

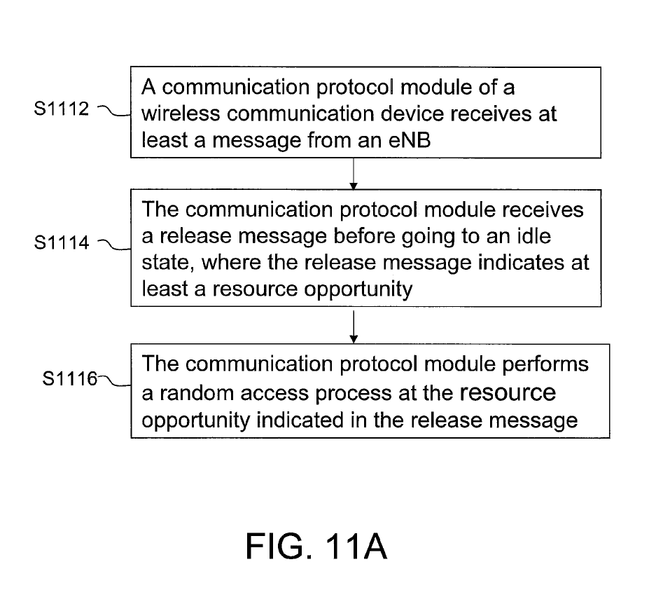

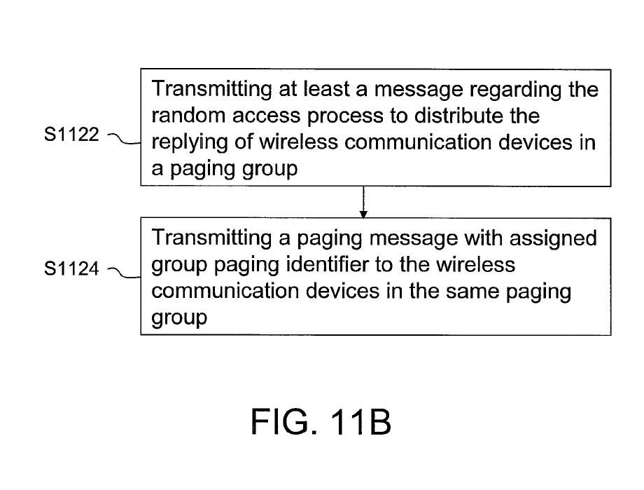

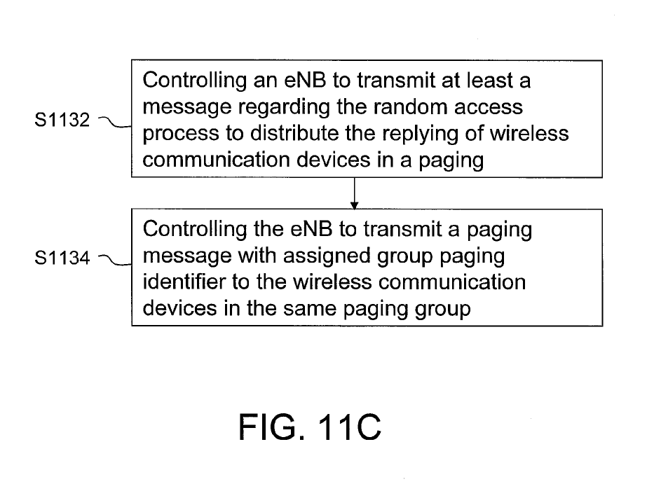

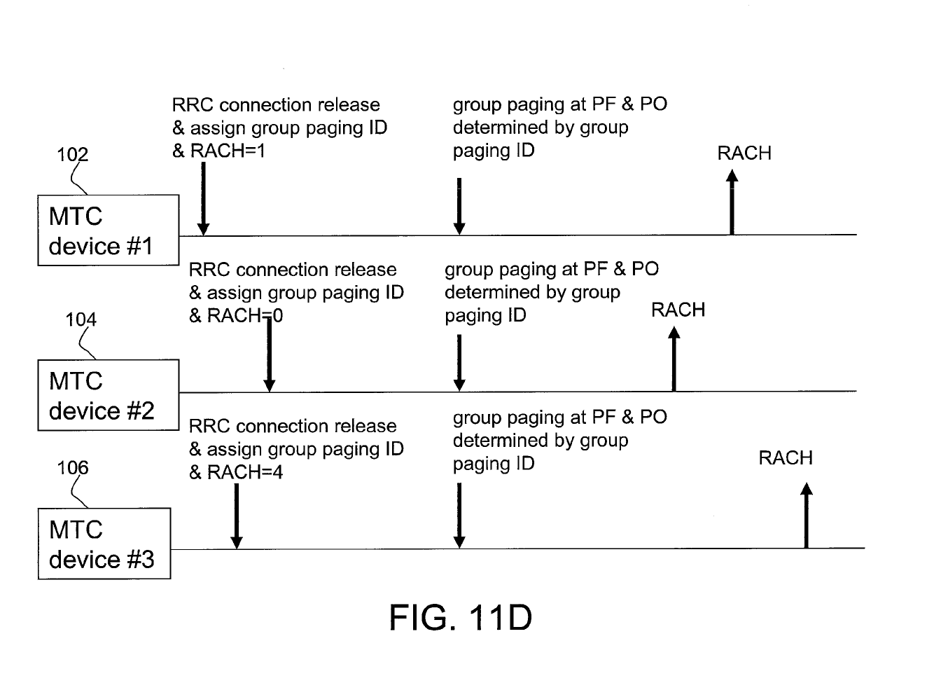

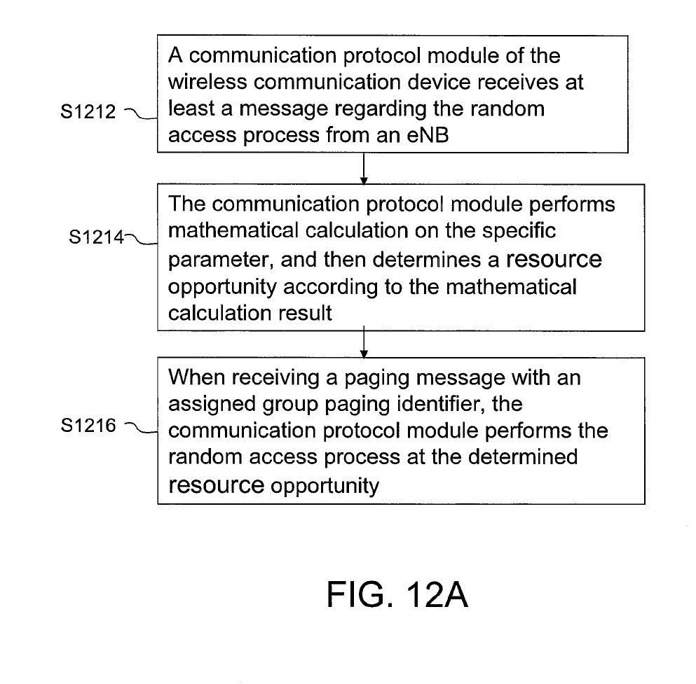

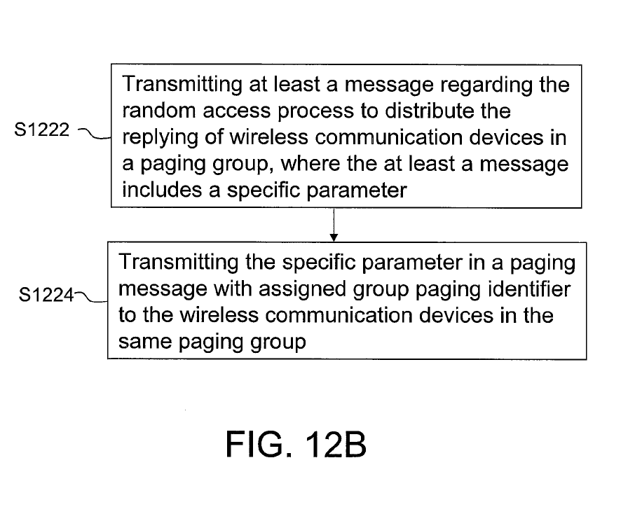

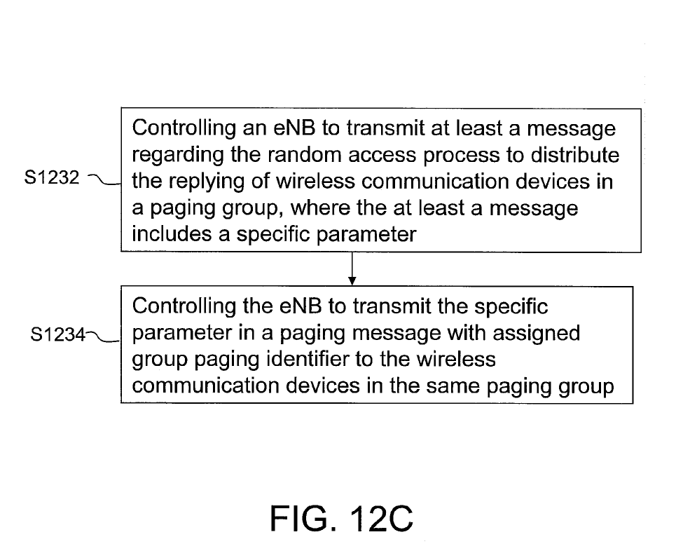

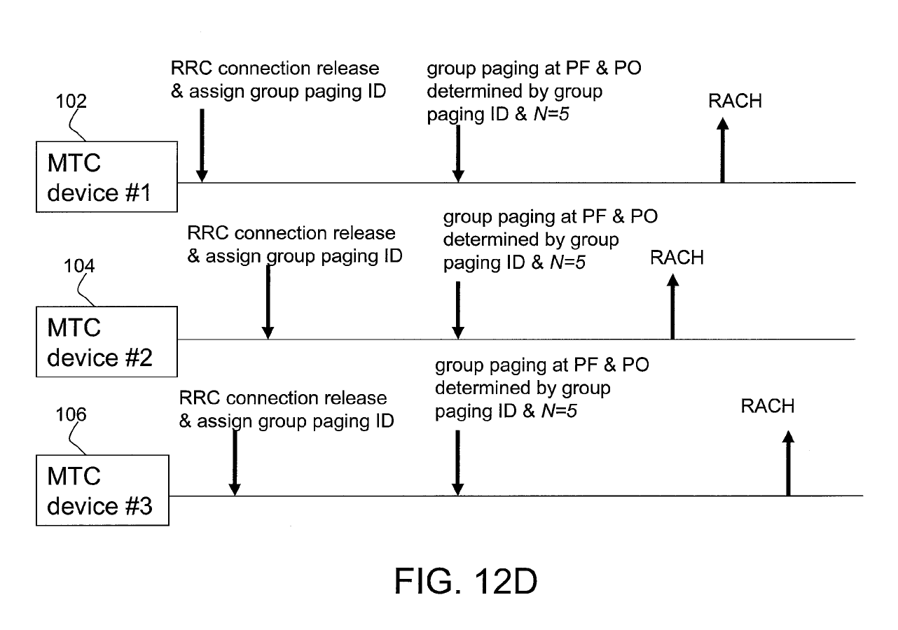

FIG. 9A is a flowchart illustrating a group paging method from a wireless communication device perspective according to a sixth exemplary embodiment. The sixth exemplary embodiment provides a generic flowchart which covers the embodiments illustrated in following FIG. 10A, FIG. 11A and FIG. 12A. Referring to FIG. 9A, the group paging method from the wireless communication device perspective of the sixth exemplary embodiment starts from step S912. In the step S912, the communication protocol module 31 of the wireless communication device 30 receives at least a message from an eNB 20. This message is associated with the random access process, and the message can be delivered from the eNB 20 to the wireless communication device 30 in the same paging group along with the group paging message, or shortly before the group paging message, or shortly after the group paging message.

In step S914, when receiving the group paging with an assigned group paging identifier from the eNB 20, the communication protocol module 31 performs the random access process according to the at least a message. The group paging method from the wireless communication device perspective is terminated after the step S914.

FIG. 9B is a flowchart illustrating a group paging method from a base station perspective according to a sixth exemplary embodiment. FIG. 9B provides a generic flowchart which covers the embodiments illustrated in following FIG. 10B, FIG. 11B and FIG. 12B. Referring to FIG. 9B, the group paging method from the base station perspective of the sixth exemplary embodiment starts from step S922. In the step S922, the communication protocol module 21 of the eNB 20 transmits at least a message regarding the random access process to distribute the replying of wireless communication devices in a paging group. In step S924, the communication protocol module 21 transmits a paging message with assigned group paging identifiers respectively to the wireless communication devices in the same paging group. The group paging method from the base station perspective is terminated after the step S924.

FIG. 9C is a flowchart illustrating a group paging method from a paging controller perspective according to a sixth exemplary embodiment. Referring to FIG. 9C, the group paging method from the paging controller perspective of the sixth exemplary embodiment starts from step S932. In the step S932, the paging controller controls the eNB 20 to transmit at least a message regarding the random access process to distribute the replying of wireless communication devices in a paging group. In step S934, the paging controller controls the eNB 20 to transmit a paging message with assigned group paging identifiers respectively to the wireless communication devices in the same paging group. The group paging method from the paging controller perspective is terminated after the step S934.

FIG. 10A a flowchart illustrating a group paging method from a wireless communication device perspective according to a seventh exemplary embodiment. In the seventh exemplary embodiment, an eNB generally transmits one or more messages regarding the random access process in order to distribute the replying of wireless communication devices in a paging group. Further, the eNB transmit a paging message with assigned group paging identifiers respectively to wireless communication devices in the same paging group. The messages from the eNB is regarding the random access process, for example, operating parameter of a push-based RACH process. In general, the push-based RACH process can be a Specific Back-off (BO) scheme or an Access Class Barring (ACB) scheme.

In the Specific Back-off (BO) scheme, MTC devices can respectively use a MTC specific BO time to delay their RACH (re-)attempts. For example, the BO time for a normal UE is 20 ms which UE would randomly pick up a timing value within the 20 ms to perform re-attempt when there is collision on RACH. Oppositely, the BO time for the MTC devices is set to 240 ms to differentiate the attempt for the normal UE and the MTC devices. The longer the BO time for MTC devices is, the higher successful rate of the normal UE can be. However, the long BO time for MTC devices can also increase longer delay to MTC devices.

In the Access Class Barring (ACB) scheme, the MTC device draws a random value and compares the random number with a pre-defined factor. Depending on the comparison, the MTC device considers that the eNB is barred or not barred. This ACB scheme allows a portion of all MTC devices within that access class with different comparison factor to enter the wireless communication network, thereby distributing the load and accesses.

For the seventh exemplary embodiment, an eNB does not need to indicate to the wireless communication device to use any particular push-based RACH process. Alternatively, the parameter of specific BO scheme and the ACB scheme are broadcast to the wireless communication devices in system information in advance, and the wireless communication devices are defined to follow those push-based random access rule when receiving paging messages.

In the seventh exemplary embodiment, for example, when a wireless communication device receives a group paging message which records its group paging ID, and indicates a specific back-off (BO) scheme or a specific Access Class Barring (ACB) scheme, the wireless communication device can apply the specific BO timer or the ACB scheme for the wireless communication device to determine when to make RACH attempt. In other word, the message forwarded from eNB(s) indicates a specific pushed-based RACH process, and the specific pushed-based RACH process comprises a back-off scheme and an access class barring scheme. Due to long delay introduced by those two schemes, the network server (or the eNB or the paging controller) can set longer expiry duration for the timer T2 so as to wait for the response from the wireless communication device(s).

Referring to FIG. 10A, the group paging method from the wireless communication device perspective of the seventh exemplary embodiment starts from step S1012. In the step S1012, the communication protocol module 31 of the wireless communication device 30 receives at least a message from an eNB 20. This message is associated with the random access process, and the at least a message indicates a specific random access process.

In step S1014, when receiving the group paging with an assigned group paging identifier from the eNB 20, the communication protocol module 31 performs the specific random access process by following the parameters transmitted in system information, where the specific random access process can be a back-off scheme or an access class barring scheme. The group paging method from the wireless communication device perspective is terminated after the step S1014.

FIG. 10B is a flowchart illustrating a group paging method from a base station perspective according to a seventh exemplary embodiment. Referring to FIG. 10B, the group paging method from the base station perspective of the seventh exemplary embodiment starts from step S1022. In the step S1022, the communication protocol module 21 of the eNB 20 transmits at least a message regarding the random access process to distribute the replying of wireless communication devices in a paging group. The at least a message indicates a specific random access process regarding the replying to the paging message with the assigned group paging identifier, and the specific random access process can be a back-off scheme or an access class barring scheme. In step S1024, the communication protocol module 21 transmits a paging message with assigned group paging identifiers respectively to the wireless communication devices in the same paging group. The group paging method from the base station perspective is terminated after the step S1024.

FIG. 10C is a flowchart illustrating a group paging method from a paging controller perspective according to a seventh exemplary embodiment. Referring to FIG. 10C, the group paging method from the paging controller perspective of the seventh exemplary embodiment starts from step S1032. In the step S1032, the paging controller controls an eNB 20 to transmit at least a message regarding the random access process to distribute the replying of wireless communication devices in a paging group. The at least a message indicates a specific random access process regarding the replying to the paging message with the assigned group paging identifier, and the specific random access process can be a back-off scheme or an access class barring scheme. In step S1034, the paging controller controls the eNB 20 to transmit a paging message with assigned group paging identifiers respectively to the wireless communication devices in the same paging group. The group paging method from the base station perspective is terminated after the step S1034.

FIG. 11A a flowchart illustrating a group paging method from a wireless communication device perspective according to an eighth exemplary embodiment. Referring to FIG. 11A, the group paging method from the wireless communication device perspective of the eighth exemplary embodiment starts from step S1112. In the step S1112, the communication protocol module 31 of the wireless communication device 30 receives at least a message from an eNB 20. The at least a message is associated with a random access process, and includes a specific radio resource control (RRC) connection release message to wireless communication device(s) in the same paging group. The RRC connection release message can explicitly indicate a specific RACH (or a resource opportunity) at which the wireless communication devices in the same paging group should perform RACH attempts.

In step S1114, the communication protocol module 31 receives the release message before entering an idle state, where the release message indicates at least one resource opportunity. In step S1116, the communication protocol module 31 performs a random access process at the resource opportunity indicated in the release message. The group paging method from the wireless communication device perspective is terminated after the step S1116.

FIG. 11B is a flowchart illustrating a group paging method from a base station perspective according to an eighth exemplary embodiment. Referring to FIG. 11B, the group paging method from the base station perspective of the eighth exemplary embodiment starts from step S1122. In the step S1122, the communication protocol module 21 of the eNB 20 transmits at least a message regarding the random access process to distribute the replying of wireless communication devices in a paging group. The at least a message includes a release message, and the release message is transmitted by the communication protocol module 21 respectively to the wireless communication devices before the wireless communication devices entering an idle state. The release message includes an indication of at least one opportunity. In step S1124, the communication protocol module 21 transmits a paging message with assigned group paging identifiers respectively to the wireless communication devices in the same paging group. The group paging method from the base station perspective is terminated after the step S1124.

FIG. 11C is a flowchart illustrating a group paging method from a paging controller perspective according to an eighth exemplary embodiment. Referring to FIG. 11C, the group paging method from the paging controller perspective of the eighth exemplary embodiment starts from step S1132. In the step S1132, the paging controller controls the eNB 20 to transmit at least a message regarding the random access process to distribute the replying of wireless communication devices in a paging group. The at least a message includes a release message, and in the step of transmitting the at least a message, the paging controller controls the eNB 20 to transmit the release message respectively to the wireless communication devices before the wireless communication devices entering an idle state, where the release message includes an indication of at least one opportunity. In step S1134, the paging controller controls the eNB 20 to transmit a paging message with assigned group paging identifiers respectively to the wireless communication devices in the same paging group. The group paging method from the base station perspective is terminated after the step S1134.

In the eighth exemplary embodiment, for example, when the network server (or the eNB or the paging controller) sends RRC connection release message to a MTC device, it could additionally indicate which RACH opportunity should attempt after receiving group paging. FIG. 11D illustrates an example of this embodiment. FIG. 11D is schematic diagram illustrating the group paging method according to the eighth exemplary embodiment. MTC device #1 (labeled as 102) can be assigned, in the RRC connection release message, a parameter “RACH=1” recommends the MTC device #1 perform RACH attempt at an incoming second RACH after the group paging message. Also, the MTC device #1, MTC device #2 (labeled as 104), and MTC device #3 (labeled as 106) are all assigned the same group paging ID and their respective RACH parameters.

The communication protocol module 21 of the eNB 20 can send the group paging message at PF and PO (determined by the group paging ID) to the wireless communication devices. As can be shown in FIG. 6D, with different values assigned to different MTC device (such as RACH=0 assigned to MTC device #2, RACH=4 assigned to MTC device #3), it can avoid congestion or collision on the RACH.

FIG. 12A a flowchart illustrating a group paging method from a wireless communication device according to a ninth exemplary embodiment. Every RRC connection message needs additional parameter(s) for implementing the eighth exemplary embodiment. Unlike the eighth exemplary embodiment, the ninth embodiment can use a common value, for example, a parameter “N” in the group paging message. Each wireless communication device(s) in the same paging group can perform its own mathematical operation (e.g., a hash function operation, or a modulo operation) with its UE identity and the parameter “N”, or perform randomization function based on the value to get another value which stands for which number of incoming RACH it can attempt the RACH process.

Referring to FIG. 12A, the group paging method from the wireless communication device of the ninth exemplary embodiment starts from step S1212. In the step S1212, the communication protocol module 31 of the wireless communication device 30 receives at least a message regarding the random access process from an eNB 20. The at least a message includes a specific parameter N to be transmitted to wireless communication device(s) in the same paging group. The specific parameter N can be delivered to the wireless communication device 30 in the same paging group along with the group paging message, or shortly before the group paging message, or shortly after the group paging message.

In the step S1214, the communication protocol module 31 performs mathematical calculation on the specific parameter N, and then determines a resource opportunity according to the mathematical calculation result. For example, the mathematical calculation on the specific parameter can be randomization, or mathematical operations on the specific parameter N. Alternatively, the wireless communication device can perform the calculation with the specific parameter and its device identifier on the specific parameter N.

In step S1216, when receiving paging message with an assigned group paging identifier, the communication protocol module 31 performs the random access process at the determined resource opportunity. The group paging method from the wireless communication device is terminated after the step S1216.

FIG. 12B is a flowchart illustrating a group paging method from a base station perspective according to a ninth exemplary embodiment. Referring to FIG. 12B, the group paging method from the base station perspective of the ninth exemplary embodiment starts from step S1222. In the step S1222, the communication protocol module 21 of the eNB 20 transmits at least a message regarding a random access process to distribute the replying of wireless communication devices in a paging group. The at least a message includes a specific parameter. In step S1224, the communication protocol module 21 transmits the specific parameter in a paging message with an assigned group paging identifier to the wireless communication devices in the same paging group. The group paging method from the base station perspective is terminated after the step S1224.

FIG. 12C is a flowchart illustrating a group paging method from a paging controller perspective according to a ninth exemplary embodiment. Referring to FIG. 12C, the group paging method from the paging controller perspective of the ninth exemplary embodiment starts from step S1232. In the step S1232, the paging controller controls the eNB 20 to transmit at least a message regarding the random access process to distribute the replying of wireless communication devices in a paging group. The at least a message includes a specific parameter. In step S1234, the paging controller controls the eNB 20 to transmit the specific parameter in a paging message with assigned group paging identifiers respectively to the wireless communication devices in the same paging group. The group paging method from the paging controller perspective is terminated after the step S1234.

FIG. 12D is schematic diagram illustrating the group paging method according to the ninth exemplary embodiment. FIG. 12D shows an example of the ninth embodiment. The parameter “N=5” is assigned in the group paging message and the hash function is the pre-determined equation of “UE ID mode N” indicated previously in system information from the eNB, then MTC device #1 with UE ID=6 (the UE ID is S-TMSI in this example) can calculate a value “1” after receiving the group paging and make RACH attempt at the incoming second RACH. Similarly, MTC device #2 with UE ID=1030 can do the calculation and get the value “0” to make the RACH attempt at the incoming first RACH. MTC device #3 with UE ID=9 can do the calculation and get the value “4” to make the RACH attempt at the incoming fifth RACH. Alternatively, the parameter “N” can be indicated in system information, and different paging group can have different parameter values or the same parameter value.

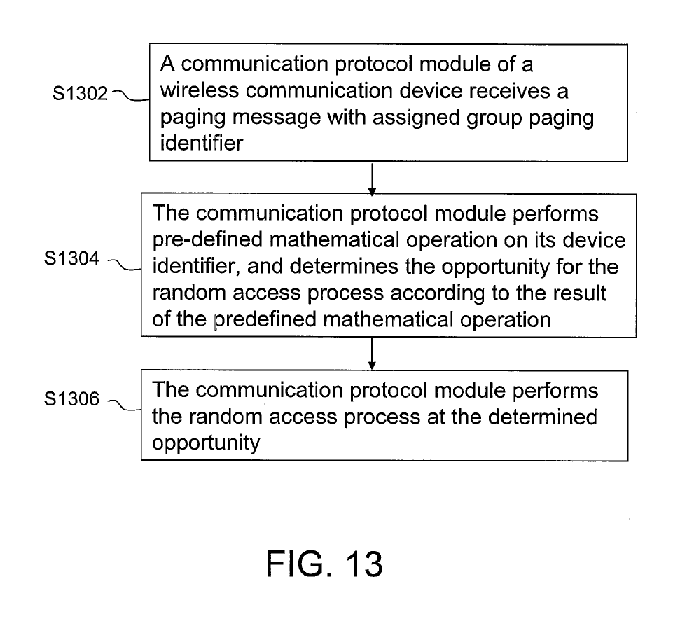

FIG. 13 is a flowchart illustrating a group paging method from a wireless communication device perspective according to a tenth exemplary embodiment. The tenth exemplary embodiment is different form the aforementioned exemplary embodiments shown in FIGS. 9A, 10A, 11A and 12A. In the tenth exemplary embodiment, there is no indication associated with an opportunity of the random access process given from the eNB (or the network server, or the paging controller) to the wireless communication device(s) in the same paging group. Instead, the wireless communication device(s) implement its own time control procedure for performing the random access process.

The group paging method from the wireless communication device perspective of the tenth exemplary embodiment starts from step S1302. In the step S1302, a communication protocol module 31 of a wireless communication device 30 receives a paging message with an assigned group paging identifier. In step S1304, the communication protocol module 31 performs pre-defined mathematical operation(s) on its own device identifier, and then determines the opportunity for the random access process according to the result of the predefined mathematical operation. In step S1306, the communication protocol module 31 performs the random access process at the determined opportunity. The group paging method from the wireless communication device is terminated after the step S1306.

For example, in the tenth exemplary embodiment, a wireless communication device can do a pre-determined Boolean function on its device identifier and get the number of RACH at which it can attempt after receiving group paging. For example, a bit-combing operation can be used such that the device identifier (such as an UE ID) is originally expressed in 32 bit, and communication protocol module 31 of the wireless communication device can sum all bits (the value can be: 0-32) and then expressed it in 6 bits, and sum of all bits again (the value can be: 0-6), and further determines final value as the number of RACH to make the attempt after receiving paging message. The present disclosure is not limited to the aforementioned example, and in other embodiments, other functions can be also applied to the tenth exemplary embodiment and there is a trade-off between the calculation complexity and the diversity of the RACH attempts.

In summary, according to the exemplary embodiments of the disclosure, a group paging methods and a wireless communication device and a base station using the same method are proposed. Group paging IDs are partitioned into different pools and assigned based on mobility of wireless communication device. Also, when the network server (or the base station or the paging controller) wants to paging a group, it is to page specific MTC devices which do not respond to the previous group paging, or repeat the group paging, and a wireless communication device ignores the repeated group paging when it has responded to the previous group paging in a period of time. Moreover, a wireless communication device responds to the group paging at a RACH based on the indicator given in its idle information or the indicator given in paging message with some pre-determined mathematical operation or the pre-determined mathematical calculations on its device identity.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A group paging method, adapted for paging a plurality of wireless communication devices, comprising:
reporting, at a wireless communication device, a mobility information to a base station when camping on the base station;
receiving, at the wireless communication device, a message indicating an assigned group paging identifier according to the mobility information; and
receiving, at the wireless communication device, a paging message comprising the assigned group paging identifier.

2. The group paging method according to claim 1, further comprising:
indicating by the mobility information whether the currently reporting wireless communication device is mobile or of fixed location.

3. A group paging method, adapted for a base station paging a plurality of wireless communication devices, comprising:
receiving, at the base station, a mobility information respectively from the wireless communication devices;
forwarding, at the base station, the mobility information to a paging controller;
receiving, at the base station, group paging identifiers assigned to the wireless communication devices respectively according to the mobility information;
transmitting, at the base station, at least a message indicating the respectively assigned group paging identifiers to the wireless communication devices; and
transmitting, at the base station, a paging message comprising the assigned group identifier, to one group of the wireless communication devices.

4. The group paging method according to claim 3, wherein the mobility information indicates whether the currently reporting wireless communication device is mobile or of fixed location.

5. The group paging method according to claim 3, wherein:
the base station is grouped into a first paging area with other base stations by the paging controller, wherein the first paging area is associated with a first assigned group paging identifier; and
the base station is grouped into a second paging area without other base stations by the paging controller, wherein the second paging area is associated with a second assigned group paging identifier.

6. The group paging method according to claim 5, wherein when the base station transmits the paging message to the group of wireless communication devices with the first assigned group paging identifier, other base stations in the first paging area also make the paging for the group of wireless communication devices.

7. The group paging method according to claim 5, wherein when the base station transmits the paging message to the wireless communication devices with the second assigned group paging identifier, only the base station in the second paging area makes the paging.

8. A wireless communication device, adapted for responding to group paging of a base station, comprising:
a transceiver module, configured for transmitting signal to the base station and receiving signal from the base station; and
a communication protocol module, connected to the transceiver module, configured for reporting a mobility information to the base station when camping on the base station, receiving message indicating an assigned group paging identifier according to the mobility information, and receiving a paging message comprising the assigned group identifier.

9. The wireless communication device according to claim 8, wherein the mobility information indicates whether the currently reporting wireless communication device is mobile or of fixed location.

10. A base station, adapted for paging a plurality of wireless communication devices, comprising:
a transceiver module, configured for transmitting signal to at least one wireless communication device and receiving signal from the at least one wireless communication device; and
a communication protocol module, connected to the transceiver module, configured for receiving mobility information respectively from the at least one wireless communication devices, forwarding the mobility information to a paging controller, receiving group paging identifiers assigned to the wireless communication devices respectively according to the mobility information, transmitting at least a message indicating the respectively assigned group paging identifiers to the wireless communication devices, and transmitting a paging message, comprising the assigned group identifier, to one paging group of the wireless communication devices.

11. The base station according to claim 10, wherein the mobility information indicates whether the currently reporting wireless communication device is mobile or of fixed location.

12. The base station according to claim 10, wherein:
the base station is grouped into a first paging area with other base stations by the paging controller, wherein the first paging area is associated with a first assigned group paging identifier; and
the base station is grouped into a second paging area without other base stations by the paging controller, wherein the second paging area is associated with a second assigned group paging identifier.

13. The base station according to claim 12, wherein when the base station transmits the paging message to the group of wireless communication devices with the first assigned group paging identifier, other base stations in the first paging area also make the paging for the group of wireless communication devices.

14. The base station according to claim 12, wherein when the base station transmits the paging message to the wireless communication devices with the second assigned group paging identifier, only the base station in the second paging area makes the paging.

15. A group paging method, adapted for paging a plurality of wireless communication devices, comprising:
when receiving a first paging message with an assigned group paging identifier from a base station, a wireless communication device replying at least a content to the base station; and
when receiving a second paging message with the assigned group identifier, the wireless communication device, which has responded previously to the first paging message, determining to ignore the second paging message.

16. The group paging method according to claim 15, wherein the at least a content is a device identifier of the wireless communication device.

17. The group paging method according to claim 15, further comprises:
the wireless communication device initiating a timer when replying the at least a content to the base station; and
when receiving the second paging message, the wireless communication devices determining to ignore the second paging message before the timer expires.

18. The group paging method according to claim 15, further comprises:
when receiving the second paging message indicating the second paging message is the repeated paging message of the first paging message, the wireless communication device which has responded previously to the first paging message determining to ignore the second paging message.

19. The group paging method according to claim 18, wherein the second paging message comprises an indicator which is used to indicate the repeat of the first paging message.

20. A group paging method, adapted for a base station paging a plurality of wireless communication devices, comprising:
transmitting, at the base station, a first paging message with an assigned group paging identifier to a paging group of wireless communication devices;
receiving, the base station, at least a content respectively from some wireless communication devices in the paging group;
checking, the base station, the at least a replied content respectively from the some wireless communication devices in the paging group; and
determining, the base station, to transmit a second paging message or transmit at least a paging message with at least a device identifier respectively to the wireless communication devices which did not respond to the first paging message or terminate the paging.

21. The group paging method according to claim 20, wherein the step of the base station determining to transmit the second paging message comprises:
indicating that the second paging message is the repeat of the first paging message by the base station to the wireless communication devices in the paging group.

22. The group paging method according to claim 21, wherein the second paging message comprises an indicator which is used to indicate the second paging message is the repeat of the first paging message.

23. A wireless communication device, adapted for responding to group paging from a base station, comprising:
a transceiver module, configured for transmitting signal to the base station and receiving signal from the base station; and
a communication protocol module, connected to the transceiver module, configured for replying at least a content to the base station when receiving a first paging message with an assigned group identifier from the base station; and
the communication protocol module, which has responded previously to the first paging, is configured for determining to ignore a second paging with the assigned group identifier when receiving the second paging message.

24. The wireless communication device according to claim 23, wherein the at least a content is a device identifier of the wireless communication device.

25. The wireless communication device according to claim 23, wherein the communication protocol module initiates a timer when replying the at least a content to the base station, and when receiving the second paging message, the communication protocol module determines to ignore the second paging message before the timer expires.

26. The wireless communication device according to claim 23, wherein when receiving the second paging message, the communication protocol module determines to ignore the second paging message indicating the second paging message is the repeated paging message of the first paging message.

27. The wireless communication device according to claim 26, wherein the second paging message comprises an indicator which is used to indicate the repeat of the first paging message.

28. A base station, adapted for paging a plurality of wireless communication devices, comprising:
a transceiver module, configured for transmitting signal to at least one wireless communication device and receiving signal from the at least one wireless communication device;
a communication protocol module, connected to the transceiver module, configured for transmitting a first paging message with an assigned group identifier to a paging group of wireless communication devices, receiving at least a content respectively from some wireless communication devices in the paging group, and checking the at least a replied content respectively from the wireless communication devices in the paging group; and
the communication protocol module is configured for further determining to transmit a second paging message or transmit at least a paging message with at least a device identifier respectively to the wireless communication devices which did not respond to the first group paging, or terminate the paging.

29. The base station, according to claim 28, wherein, when transmitting the second paging message, the communication protocol module indicates that the second paging message is the repeat of the first paging message to the wireless communication devices in the paging group.

30. The base station, according to claim 28, wherein the second paging message comprises an indicator which is used to indicate the second paging message is the repeat of the first paging message.

31. A group paging method, adapted for paging a plurality of wireless communication devices, comprising:
receiving, at a wireless communication device, at least a message from a base station, and
performing, at the wireless communication device, a random access process according to the at least a message when receiving a paging message with an assigned group paging identifier.

32. The group paging method according to claim 31, wherein the at least a message comprises a system information message, and the method further comprises:
performing, at the wireless communication device, a specific random access process according to operations and parameters indicated in the system information message.

33. The group paging method according to claim 32, wherein the random access process comprises a back-off scheme and a barring scheme.

34. The group paging method according to claim 31, wherein:
the at least a message comprises a release message indicating a resource opportunity;
the wireless communication device receiving the release message before entering an idle state; and
the wireless communication device performing the random access process at the resource opportunity.

35. The group paging method according to claim 31, wherein the at least a message comprises a specific parameter, and the method further comprises:
the wireless communication device performing mathematical calculation on the specific parameter, and then determining a resource opportunity according to the mathematical calculation result; and
the wireless communication device performing the random access process at the determined resource opportunity.

36. The group paging method according to claim 35, wherein the wireless communication device receives the specific parameter within the paging message.

37. The group paging method according to claim 35, wherein the mathematical calculation on the specific parameter comprises:
performing the calculation with the specific parameter and a device identifier of the wireless communication device.

38. A group paging method, adapted for a base station paging a plurality of wireless communication devices, comprising:
transmitting, at the base station, at least a message regarding a random access process to distribute the replying of wireless communication devices in a paging group; and
transmitting, at the base station, a paging message with an assigned group paging identifier to the wireless communication devices in the same paging group.

39. The group paging method according to claim 38, wherein the at least a message indicates a specific random access process and related parameters regarding the replying to the paging message with the assigned group paging identifier.

40. The group paging method according to claim 39, wherein the specific random access process comprises a back-off scheme and a barring scheme.

41. The group paging method according to claim 38, wherein the at least a message comprises a release message, and the method further comprises:
transmitting, at the base station, the release message respectively to the wireless communication devices before the wireless communication devices entering an idle state, wherein the release message indicates a resource opportunity.

42. The group paging method according to claim 38, wherein the at least a message comprises a specific parameter, further comprises:
transmitting, at the base station, the specific parameter in a paging message with the assigned group paging identifier.

43. A wireless communication device, adapted for responding to group paging of a base station, comprising:
a transceiver module, configured for transmitting signal to the base station and receiving signal from the base station; and
a communication protocol module, connected to the transceiver module, configured for receiving at least a message from the base station, and performing the random access process according to the at least a message when receiving a paging message with an assigned group identifier.

44. The wireless communication device according to claim 43, wherein the at least a message comprising a system information message, and the communication protocol module performs a specific random access process according to operations and parameters indicated in the system information message.

45. The wireless communication device according to claim 44, wherein the specific random access process comprises a back-off scheme and an access class barring scheme.

46. The wireless communication device according to claim 43, wherein:
the at least a message comprises a release message indicating a resource opportunity;
the communication protocol module receives the release message before entering an idle state; and
the communication protocol module performs the random access process at the resource opportunity.

47. The wireless communication device according to claim 43, wherein:
the at least a message comprises a specific parameter;
the communication protocol module performs mathematical calculation on the specific parameter, and then determines a resource opportunity according to the mathematical calculation result; and
the communication protocol module further performs the random access process at the determined resource opportunity.

48. The wireless communication device according to claim 47, wherein the communication protocol module receives the specific parameter within the paging message.

49. The wireless communication device according to claim 47, wherein the mathematical calculation on the specific parameter comprises:
performing the calculation with the specific parameter and a device identifier of the wireless communication device.

50. A base station, adapted for paging a plurality of wireless communication devices, comprising:
a transceiver module, configured for transmitting signal to at least one wireless communication device and receiving signal from the at least one wireless communication device; and
a communication protocol module, connected to the transceiver module, configured for transmitting at least a message regarding a random access process to distribute the replying of wireless communication devices in a paging group, and transmitting a paging message with an assigned group paging identifier to the wireless communication devices in the same paging group.

51. The base station according to claim 50, wherein the at least a message indicates a specific random access process and related parameters regarding the replying to the paging message with the assigned group paging identifier.

52. The base station according to claim 51, wherein the specific random access process comprises a back-off scheme and barring scheme.

53. The base station according to claim 50, wherein the at least a message comprises a release message, and the communication protocol module transmits the release message respectively to the wireless communication devices before the wireless communication devices respectively entering an idle state, wherein the release message indicates a resource opportunity.

54. The base station according to claim 50, wherein the at least a message comprises a specific parameter, and the communication protocol module transmits the specific parameter in a paging message with the assigned group identifier.

55. A group paging method, comprising:
receiving, at a wireless communication devices, a paging message with a group paging identifier;
performing, at the wireless communication device, a predefined mathematical operation on a device identifier of the wireless communication device;
determining, at the wireless communication device, a resource opportunity for a random access process according to the result of the predefined mathematical operation; and
performing, at the wireless communication device, the random access process at the determined resource opportunity.

56. The group paging method according to claim 55, wherein the predefined mathematical operation comprises a Boolean function and a bit-coming operation, and the result of the predefined mathematical operation on the device identifier indicates the resource opportunity at which the wireless communication device performs the random access process.

57. A wireless communication device, adapted for replying to a paging message with a group paging identifier, comprising:
a transceiver module, configured for transmitting signal to a base station and receiving signal from the base station; and
a communication protocol module, connected to the transceiver module, configured for receiving a paging message with a group paging identifier, performing a predefined mathematical operation on a device identifier of the wireless communication device, then determining a resource opportunity according to the result of the predefined mathematical operation, and further performing a random access process at the determined resource opportunity.

58. The wireless communication device according to claim 57, wherein the predefined mathematical operation comprises a Boolean function and a bit-coming operation, and the result of the predefined mathematical operation on the device identifier indicates the resource opportunity at which the wireless communication device perform the random access process.

59. A group paging method, adapted for a paging controller, comprising:
grouping a plurality of base stations into different paging areas with associated group paging identifiers;
receiving reports of mobility information of the wireless communication devices from a base station; and
assigning respectively the group paging identifiers to the wireless communication devices according to their mobility information.

60. The group paging method according to claim 59, wherein the mobility information indicates whether the wireless communication device is mobile or of fixed location.

61. The group paging method according to claim 59, wherein the step of assigning respectively the group paging identifiers to the wireless communication devices comprises:
when the wireless communication devices of the paging group are determined being mobile, then assigning a first group paging identifier; and
when the wireless communication devices of the paging group are determined being of fixed position, then assigning a second group paging identifier.

62. The group paging method according to claim 61, further comprising:
when the paging controller intends to page a wireless communication device with the first group paging identifier, the paging controller requests the base stations in a first paging area to make the group paging.

63. The group paging method according to claim 59, further comprising:
when the paging controller intends to page the wireless communication device with the second group paging identifier, the paging controller requests only one base station in a second paging area to make the group paging.

64. A paging controller, adapted for group paging a plurality of wireless communication devices, comprising:
a control module, connected to a plurality of base stations, configured for grouping the base stations into different paging areas with associated group paging identifiers, receiving reports of mobility information of the wireless communication devices from a base station, and assigning respectively the group paging identifiers to the wireless communication devices according to their mobility information.

65. The paging controller according to claim 64, wherein the mobility information indicates whether the wireless communication device is mobile or of fixed location.

66. The paging controller according to claim 64, wherein:
when the wireless communication devices of the paging group are determined being mobile, the control module assigns a first group paging identifier; and
when the wireless communication devices of the paging group are determined being of fixed position, the control module assigns a second group paging identifier.

67. The paging controller according to claim 66, wherein when the paging controller intends to page a wireless communication device with the first group paging identifier, the control module requests the base stations in a first paging area to make the group paging.

68. The paging controller according to claim 64, wherein when the paging controller intends to page the wireless communication device with the second group paging identifier, the control module requests only one base station in a second paging area to make the group paging.
